(19) United States
(12) Patent Application Publication
(10) Pub. No.: US 2025/0240453 A1
(43) Pub. Date: Jul. 24, 2025

(54) Image Packing for 3D Mesh Displacements

(71) Applicant: Ofinno, LLC, Reston, VA (US)

(72) Inventor: Chao Cao, Reston, VA (US)

(21) Appl. No.: 19/033,818

(22) Filed: Jan. 22, 2025

Related U.S. Application Data
(60) Provisional application No. 63/623,734, filed on Jan. 22, 2024.

(51) Int. Cl. H04N 19/597; G06T 9/00; H04N 19/124; H04N 19/136; H04N 19/176; H04N 19/184; H04N 19/44; H04N 19/64

(52) U.S. Cl. CPC H04N 19/597; G06T 9/001; H04N 19/124; H04N 19/136; H04N 19/176; H04N 19/184; H04N 19/44; H04N 19/64

(57) ABSTRACT

A decoder decodes, from a bitstream, unpacking information indicating one or more packing indications for displacements associated with a subset of vertices of a set of vertices of a three-dimensional mesh. The decoder decodes, from the bitstream, an image including wavelet coefficients representing the displacements of the subset of vertices. Based on the one or more packing indications associated with the subset, the decoder unpacks the wavelet coefficients from the image to determine the displacements.

### CROSS-REFERENCE TO RELATED APPLICATIONS

This application claims the benefit of U.S. Provisional Application No. 63/623,734, filed Jan. 22, 2024, which is hereby incorporated by reference in its entirety.

### BRIEF DESCRIPTION OF THE DRAWINGS

Examples of several of the various embodiments of the present disclosure are described herein with reference to the drawings.

FIG. 1 illustrates an exemplary mesh coding/decoding system in which embodiments of the present disclosure may be implemented.

FIG. 2A illustrates a block diagram of an example encoder for intra encoding a 3D mesh, according to some embodiments.

FIG. 2B illustrates a block diagram of an example encoder for inter encoding a 3D mesh, according to some embodiments.

FIG. 3 illustrates a diagram showing an example decoder.

FIG. 4 is a diagram showing an example process for generating displacements of an input mesh (e.g., an input 3D mesh frame) to be encoded, according to some embodiments.

FIG. 5 illustrates an example process for approximating and encoding a geometry of a 3D mesh, according to some embodiments.

FIG. 6 illustrates an example of vertices of a subdivided mesh (e.g., a subdivided base mesh) corresponding to multiple levels of detail (LODs), according to some embodiments.

FIG. 7A illustrates an example of an image packed with displacements (e.g., displacement fields or vectors) using a packing scheme, according to some embodiments.

FIG. 7B illustrates an example of a packed displacement image with labeled LODs, according to some embodiments.

FIG. 8A illustrates an example of a packed displacement image with labeled LODs, including packing blocks/segments that are packed with multiple traversal scheme alternatives, according to some embodiments.

FIG. 8B illustrates an example of a packed displacement image with labeled LODs, including packing blocks/segments that are packed with multiple traversal origin alternatives, according to some embodiments.

FIG. 8C illustrates an example of a packed displacement image with labeled LODs, including packing blocks/segments that are packed with multiple traversal orientation alternatives, according to some embodiments.

FIG. 8D illustrates an example of a packed displacement image with labeled LODs, including packing blocks/segments that are packed with multiple traversal order alternatives, according to some embodiments.

FIG. 9 illustrates examples of an image packer and an image unpacker to pack and unpack, respectively, transformed-quantized wavelet coefficients representing displacements of a 3D mesh into and from an image, according to some embodiments.

FIG. 10 illustrates a flowchart of an example method for applying a packing scheme to pack transformed-quantized wavelet coefficients into an image, according to some embodiments.

FIG. 11 illustrates a flowchart of an example method for applying an unpacking scheme to unpack transformed-quantized wavelet coefficients from an image, according to some embodiments.

FIG. 12 illustrates a block diagram of an exemplary computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Traditional visual data describes an object or scene using a series of pixels that each comprise a position in two dimensions (x and y) and one or more optional attributes like color. Volumetric visual data adds another positional dimension to this traditional visual data. Volumetric visual data describes an object or scene using a series of points that each comprise a position in three dimensions (x, y, and z) and one or more optional attributes like color. Compared to traditional visual data, volumetric visual data may provide a more immersive way to experience visual data. For example, an object or scene described by volumetric visual data may be viewed from any (or multiple) angles, whereas traditional visual data may generally only be viewed from the angle in which it was captured or rendered. Volumetric visual data may be used in many applications, including Augmented Reality (AR), Virtual Reality (VR), and Mixed Reality (MR). Volumetric visual data may be in the form of a volumetric frame that describes an object or scene captured at a particular time instance or in the form of a sequence of volumetric frames (referred to as a volumetric sequence or volumetric video) that describes an object or scene captured at multiple different time instances.

One format for storing volumetric visual data is three dimensional (3D) meshes (hereinafter referred to as a mesh or a mesh frame). A mesh frame (or mesh) comprises a collection of points in three-dimensional (3D) space, also referred to as vertices. Each vertex in a mesh comprises geometry information that indicates the vertex's position in 3D space. For example, the geometry information may indicate the vertex's position in 3D space using three Cartesian coordinates (x, y, and z). Further the mesh may comprise geometry information indicating a plurality of triangles. Each triangle comprises three vertices connected by three edges and a face. One or more types of attribute information may be stored for each face (of a triangle). Attribute information may indicate a property of a face's visual appearance. For example, attribute information may indicate a texture (e.g., color) of the face, a material type of the face, transparency information of the face, reflectance information of the face, a normal vector to a surface of the face, a velocity at the face, an acceleration at the face, a time stamp indicating when the face (and/or vertex) was captured, or a modality indicating how the face (and/or vertex) was captured (e.g., running, walking, or flying). In another example, a face (or vertex) may comprise light field data in the form of multiple view-dependent texture information. Light field data may be another type of optional attribute information.

The triangles (e.g., represented by vertexes and edges) in a mesh may describe an object or a scene. For example, the triangles in a mesh may describe the external surface and/or the internal structure of an object or scene. The object or scene may be synthetically generated by a computer or may be generated from the capture of a real-world object or scene. The geometry information of a real world object or scene may be obtained by 3D scanning and/or photogrammetry. 3D scanning may include laser scanning, structured light scanning, and/or modulated light scanning. 3D scanning may obtain geometry information by moving one or more laser heads, structured light cameras, and/or modulated light cameras relative to an object or scene being scanned. Photogrammetry may obtain geometry information by triangulating the same feature or point in different spatially shifted 2D photographs. Mesh data may be in the form of a mesh frame that describes an object or scene captured at a particular time instance or in the form of a sequence of mesh frames (referred to as a mesh sequence or mesh video) that describes an object or scene captured at multiple different time instances.

The data size of a mesh frame or sequence in addition with one or more types of attribute information may be too large for storage and/or transmission in many applications. For example, a single mesh frame may comprise thousands or tens or hundreds of thousands of triangles, where each triangle (e.g., vertexes and/or edges) comprises geometry information and one or more optional types of attribute information. The geometry information of each vertex may comprise three Cartesian coordinates (x, y, and z) that are each represented, for example, using 8 bits or 24 bits in total. The attribute information of each point may comprise a texture corresponding to three color components (e.g., R, G, and B color components) that are each represented, for example, using 8 bits or 24 bits in total. A single vertex therefore comprises 48 bits of information in this example, with 24 bits of geometry information and 24 bits of texture. Encoding may be used to compress the size of a mesh frame or sequence to provide for more efficient storage and/or transmission. Decoding may be used to decompress a compressed mesh frame or sequence for display and/or other forms of consumption (e.g., by a machine learning based device, neural network based device, artificial intelligence based device, or other forms of consumption by other types of machine based processing algorithms and/or devices).

Compression of meshes may be lossy (e.g., introducing differences relative to the original data) for the distribution to and visualization by an end-user, for example on AR/VR glasses or any other 3D-capable device. Lossy compression allows for a very high ratio of compression but incurs a trade-off between compression and visual quality perceived by the end-user. Other frameworks, like medical or geological applications, may require lossless compression to avoid altering the decompressed meshes.

Volumetric visual data may be stored after being encoded into a bitstream in a container, for example, a file server in the network. The end-user may request for a specific bitstream depending on the user's requirement. The user may also request for adaptive streaming of the bitstream where the trade-off between network resource consumption and visual quality perceived by the end-user is taken into consideration by an algorithm.

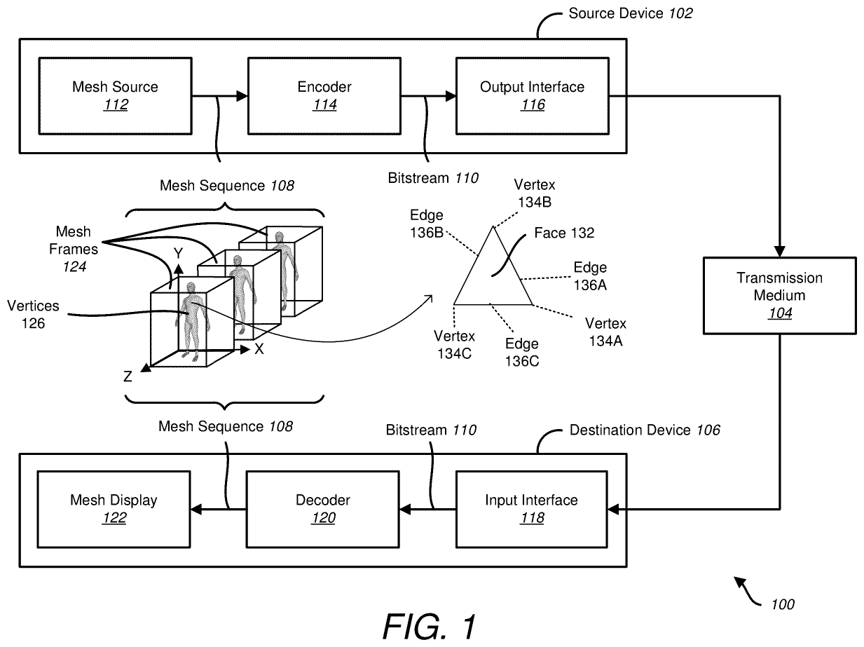

FIG. 1 illustrates an exemplary mesh coding/decoding system 100 in which embodiments of the present disclosure may be implemented. Mesh coding/decoding system 100 comprises a source device 102, a transmission medium 104, and a destination device 106. Source device 102 encodes a mesh sequence 108 into a bitstream 110 for more efficient storage and/or transmission. Source device 102 may store and/or transmit bitstream 110 to destination device 106 via transmission medium 104. Destination device 106 decodes bitstream 110 to display mesh sequence 108 or for other forms of consumption. Destination device 106 may receive bitstream 110 from source device 102 via a storage medium or transmission medium 104. Source device 102 and destination device 106 may be any one of a number of different devices, including a cluster of interconnected computer systems acting as a pool of seamless resources (also referred to as a cloud of computers or cloud computer), a server, a desktop computer, a laptop computer, a tablet computer, a smart phone, a wearable device, a television, a camera, a video gaming console, a set-top box, a video streaming device, an autonomous vehicle, or a head mounted display. A head mounted display may allow a user to view a VR, AR, or MR scene and adjust the view of the scene based on movement of the user's head. A head mounted display may be tethered to a processing device (e.g., a server, desktop computer, set-top box, or video gaming counsel) or may be fully self-contained.

To encode mesh sequence 108 into bitstream 110, source device 102 may comprise a mesh source 112, an encoder 114, and an output interface 116. Mesh source 112 may provide or generate mesh sequence 108 from a capture of a natural scene and/or a synthetically generated scene. A synthetically generated scene may be a scene comprising computer generated graphics. Mesh source 112 may comprise one or more mesh capture devices (e.g., one or more laser scanning devices, structured light scanning devices, modulated light scanning devices, and/or passive scanning devices), a mesh archive comprising previously captured natural scenes and/or synthetically generated scenes, a mesh feed interface to receive captured natural scenes and/or synthetically generated scenes from a mesh content provider, and/or a processor to generate synthetic mesh scenes.

As shown in FIG. 1, a mesh sequence 108 may comprise a series of mesh frames 124. A mesh frame describes an object or scene captured at a particular time instance. Mesh sequence 108 may achieve the impression of motion when a constant or variable time is used to successively present mesh frames 124 of mesh sequence 108. A (3D) mesh frame comprises a collection of vertices 126 in 3D space and geometry information of vertices 126. A 3D mesh may comprise a collection of vertices, edges, and faces that define the shape of a polyhedral object. Further, the mesh frame comprises a plurality of triangles (e.g., polygon triangles). For example, a triangle may include vertices 134A-C and edges 136A-C and a face 132. The faces usually consist of triangles (triangle mesh), Quadrilaterals (Quads), or other simple convex polygons (n-gons), since this simplifies rendering, but may also be more generally composed of concave polygons, or even polygons with holes. Each of vertices 126 may comprise geometry information that indicates the point's position in 3D space. For example, the geometry information may indicate the point's position in 3D space using three Cartesian coordinates (x, y, and z). For example, the geometry information may indicate the plurality of triangles with each comprising three vertices of vertices 126. One or more of the triangles may further comprise one or more types of attribute information. Attribute information may indicate a property of a point's visual appearance. For example, attribute information may indicate a texture (e.g., color) of a face, a material type of a face, transparency information of a face, reflectance information of a face, a normal vector to a surface of a face, a velocity at a face, an acceleration at a face, a time stamp indicating when a face was captured, a modality indicating when a face was captured (e.g., running, walking, or flying). In another example, one or more of the faces (or triangles) may comprise light field data in the form of multiple view-dependent texture information. Light field data may be another type of optional attribute information. Color attribute information of one or more of the faces may comprise a luminance value and two chrominance values. The luminance value may represent the brightness (or luma component, Y) of the point. The chrominance values may respectively represent the blue and red components of the point (or chroma components, Cb and Cr) separate from the brightness. Other color attribute values are possible based on different color schemes (e.g., an RGB or monochrome color scheme).

In some embodiments, a 3D mesh (e.g., one of mesh frames 124) may be a static or a dynamic mesh. In some examples, the 3D mesh may be represented (e.g., defined) by connectivity information, geometry information, and texture information (e.g., texture coordinates and texture connectivity). In some embodiments, the geometry information may represent locations of vertices of the 3D mesh in 3D space and the connectivity information may indicate how the vertices are to be connected together to form polygons (e.g., triangles) that make up the 3D mesh. Also, the texture coordinates indicate locations of pixels in a 2D image that correspond to vertices of a corresponding 3D mesh (or a sub-mesh of the 3D mesh). In some examples, patch information may indicate how the texture coordinates defined with respect to a 2D bounding box map into a 3D space of a 3D bounding box associated with the patch based on how the points were projected onto a projection plane for the patch. Also, the texture connectivity information may indicate how the vertices represented by the texture coordinates are to be connected together to form polygons of the 3D mesh (or sub-meshes). For example, each texture or attribute patch of the texture image may corresponds to a corresponding sub-mesh defined using texture coordinates and texture connectivity.

In some embodiments, for each 3D mesh, one or multiple 2D images may represent the textures or attributes associated with the mesh. For example, the texture information may include geometry information listed as X, Y, and Z coordinates of vertices and texture coordinates listed as 2D dimensional coordinates corresponding to the vertices. The example texture mesh may include texture connectivity information that indicates mappings between the geometry coordinates and texture coordinates to form polygons, such as triangles. For example, a first triangle may be formed by three vertices, where a first vertex is defined as the first geometry coordinate (e.g. 64.062500, 1237.739990, 51.757801), which corresponds with the first texture coordinate (e.g. 0.0897381, 0.740830). A second vertex of the triangle may be defined as the second geometry coordinate (e.g. 59.570301, 1236.819946, 54.899700), which corresponds with the second texture coordinate (e.g. 0.899059, 0.741542). Finally, a third vertex of the triangle may correspond to the third listed geometry coordinate which matches with the third listed texture coordinate. However, note that in some instances a vertex of a polygon, such as a triangle, may map to a set of geometry coordinates and texture coordinates that may have different index positions in the respective lists of geometry coordinates and texture coordinates. For example, the second triangle has a first vertex corresponding to the fourth listed set of geometry coordinates and the seventh listed set of texture coordinates. A second vertex corresponding to the first listed set of geometry coordinates and the first set of listed texture coordinates and a third vertex corresponding to the third listed set of geometry coordinates and the ninth listed set of texture coordinates.

Encoder 114 may encode mesh sequence 108 into bitstream 110. To encode mesh sequence 108, encoder 114 may apply one or more prediction techniques to reduce redundant information in mesh sequence 108. Redundant information is information that may be predicted at a decoder and therefore may not be needed to be transmitted to the decoder for accurate decoding of mesh sequence 108. For example, encoder 114 may convert attribute information (e.g., texture information) of one or more of mesh frames 124 from 3D to 2D and then apply one or more 2D video encoders or encoding methods to the 2D images. For example, any one of multiple different proprietary or standardized 2D video encoders/decoders may be used, including International Telecommunications Union Telecommunication Standardization Sector (ITU-T) H.1263, ITU-T H.1264 and Moving Picture Expert Group (MPEG)-4 Visual (also known as Advanced Video Coding (AVC)), ITU-T H.1265 and MPEG-H Part 2 (also known as High Efficiency Video Coding (HEVC), ITU-T H.1265 and MPEG-I Part 3 (also known as Versatile Video Coding (VVC)), the WebM VP8 and VP9 codecs, and AOMedia Video 1 (AV1). Encoder 114 may encode geometry of mesh sequence 108 based on video dynamic mesh coding (V-DMC). V-DMC specifies the encoded bitstream syntax and semantics for transmission or storage of a mesh sequence and the decoder operation for reconstructing the mesh sequence from the bitstream.

Output interface 116 may be configured to write and/or store bitstream 110 onto transmission medium 104 for transmission to destination device 106. In addition, or alternatively, output interface 116 may be configured to transmit, upload, and/or stream bitstream 110 to destination device 106 via transmission medium 104. Output interface 116 may comprise a wired and/or wireless transmitter configured to transmit, upload, and/or stream bitstream 110 according to one or more proprietary and/or standardized communication protocols, such as Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Transmission medium 104 may comprise a wireless, wired, and/or computer readable medium. For example, transmission medium 104 may comprise one or more wires, cables, air interfaces, optical discs, flash memory, and/or magnetic memory. In addition, or alternatively, transmission medium 104 may comprise one or more networks (e.g., the Internet) or file servers configured to store and/or transmit encoded video data.

To decode bitstream 110 into mesh sequence 108 for display or other forms of consumption, destination device 106 may comprise an input interface 118, a decoder 120, and a mesh display 122. Input interface 118 may be configured to read bitstream 110 stored on transmission medium 104 by source device 102. In addition, or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary and/or standardized communication protocols, such as those mentioned above.

Decoder 120 may decode mesh sequence 108 from encoded bitstream 110. To decode attribute information (e.g., textures) of mesh sequence 108, decoder 120 may reconstruct the 2D images compressed using one or more 2D video encoders. Decoder 120 may then reconstruct the attribute information of 3D mesh frames 124 from the reconstructed 2D images. In some examples, decoder 120 may decode a mesh sequence that approximates mesh sequence 108 due to, for example, lossy compression of mesh sequence 108 by encoder 114 and/or errors introduced into encoded bitstream 110 during transmission to destination device 106. Further, decoder 120 may decode geometry of mesh sequence 108 from encoded bitstream 110, as will be further described below. Then, one or more of decoded attribute information may be applied to decoded mesh frames of mesh sequence 108.

Mesh display 122 may display mesh sequence 108 to a user. Mesh display 122 may comprise a cathode rate tube (CRT) display, a liquid crystal display (LCD), a plasma display, a light emitting diode (LED) display, a 3D display, a holographic display, a head mounted display, or any other display device suitable for displaying mesh sequence 108.

It should be noted that mesh coding/decoding system 100 is presented by way of example and not limitation. In the example of FIG. 1, mesh coding/decoding system 100 may have other components and/or arrangements. For example, mesh source 112 may be external to source device 102. Similarly, mesh display 122 may be external to destination device 106 or omitted altogether where mesh sequence is intended for consumption by a machine and/or storage device. In another example, source device 102 may further comprise a mesh decoder and destination device 106 may comprise a mesh encoder. In such an example, source device 102 may be configured to further receive an encoded bit stream from destination device 106 to support two-way mesh transmission between the devices.

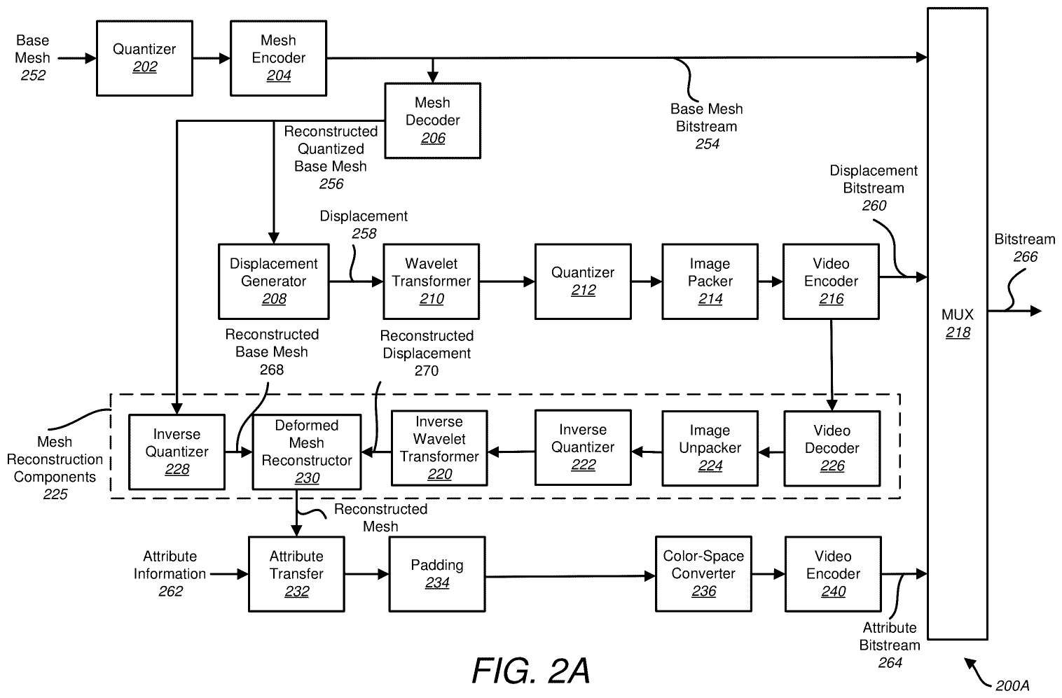

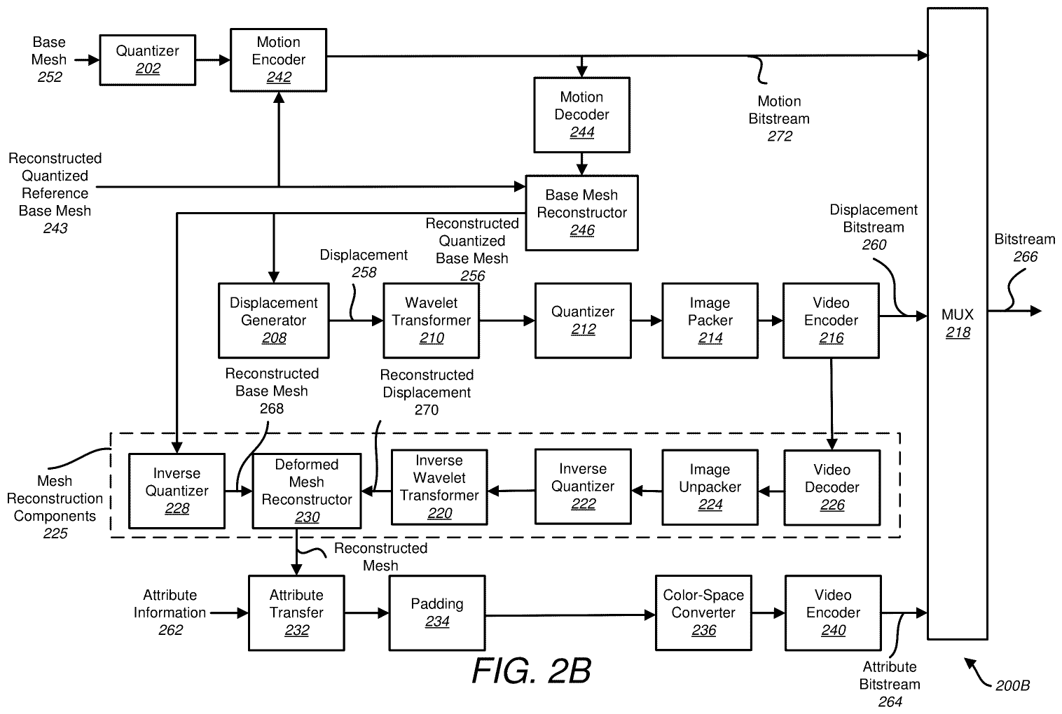

FIG. 2A illustrates a block diagram of an example encoder 200A for intra encoding a 3D mesh, according to some embodiments. For example, an encoder (e.g., encoder 114) may comprise encoder 200A.

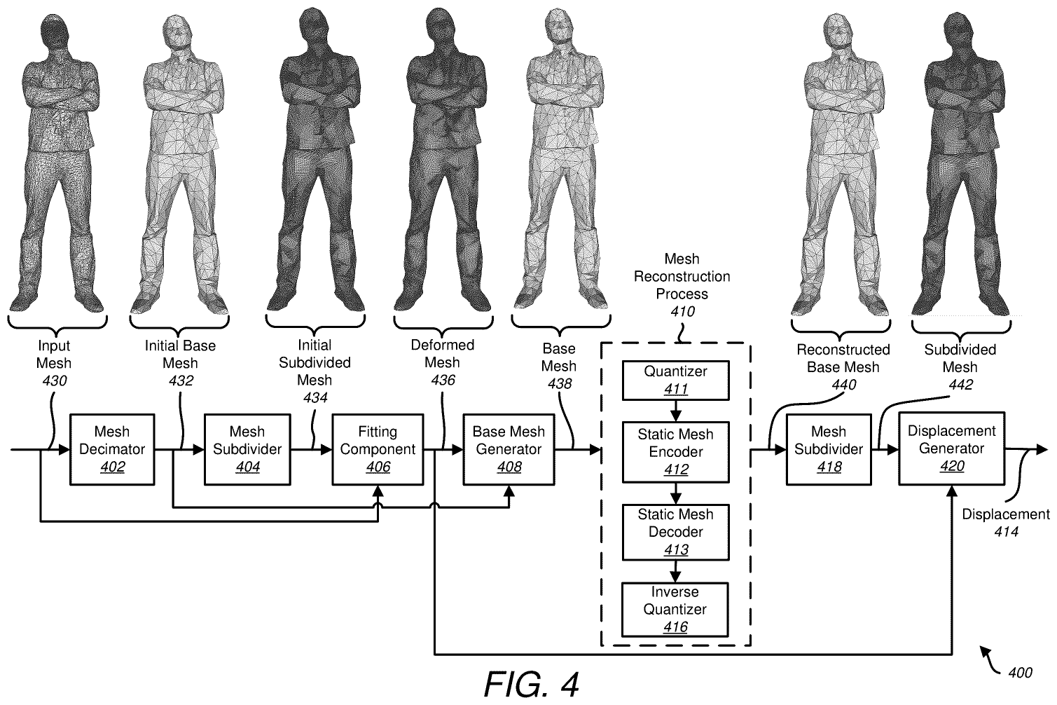

In some examples, a mesh sequence (e.g., mesh sequence 108) may include a set of mesh frames (e.g., mesh frames 124) that may be individually encoded and decoded. As will be further described below with respect to FIG. 4, a base mesh 252 may be determined (e.g., generated) from a mesh frame (e.g., an input mesh) through a decimation process. In the decimation process, the mesh topology of the mesh frame may be reduced to determine the base mesh (e.g., a decimated mesh or decimated base mesh). A mesh encoder 204 may encode base mesh 252, whose geometry information (e.g., vertices) may be quantized by quantizer 202, to generate a base mesh bitstream 254. In some examples, base mesh encoder 204 may be an existing encoder such as Draco or Edgebreaker.

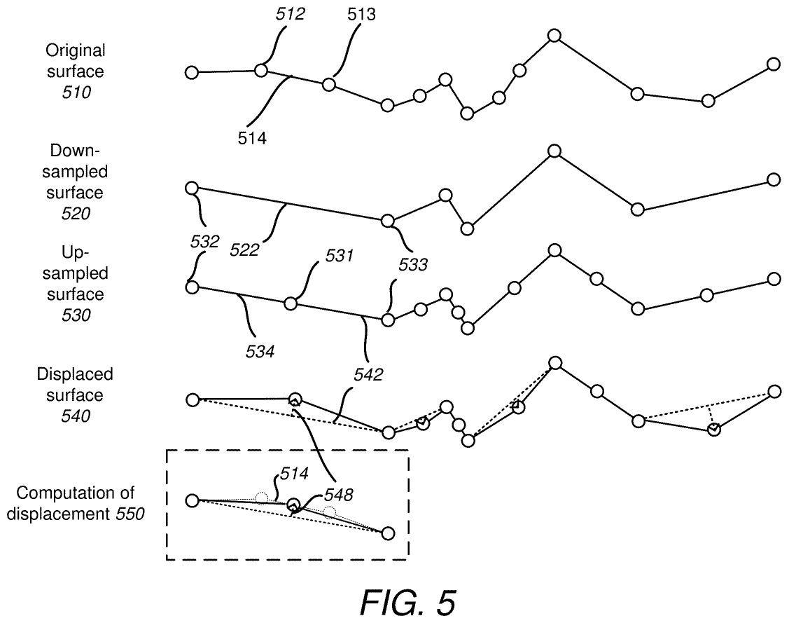

Displacement generator 208 may generate displacements for vertices of the mesh frame based on base mesh 252, as will be further explained below with respect to FIGS. 4 and 5. In some examples, the displacements are determined based on a reconstructed base mesh 256. Reconstructed base mesh 256 may be determined (e.g., output or generated) by mesh decoder 206 that decodes the encoded base mesh (e.g., in base mesh bitstream 254) determined (e.g., output or generated) by mesh encoder 204. Displacement generator 208 may subdivide reconstructed base mesh 256 using a subdivision scheme (e.g., subdivision algorithm) to determine a subdivided mesh (e.g., a subdivided base mesh). Displacement 258 may be determined based on fitting the subdivided mesh to an original input mesh surface. For example, displacement 258 for a vertex in the mesh frame may include displacement information (e.g., a displacement vector) that indicates a displacement from the position of the corresponding vertex in the subdivided mesh to the position of the vertex in the mesh frame.

Displacement 258 may be transformed by wavelet transformer 210 to generate wavelet coefficients (e.g., transformation coefficients) representing the displacement information and that may be more efficiently encoded (and subsequently decoded). The wavelet coefficients may be quantized by quantizer 212 and packed (e.g., arranged) by image packer 214 into a picture (e.g., one or more images or picture frames) to be encoded by video encoder 216. Mux 218 may combine (e.g., multiplex) the displacement bitstream 260 output by video encoder 216 together with base mesh bitstream 254 to form bitstream 266.

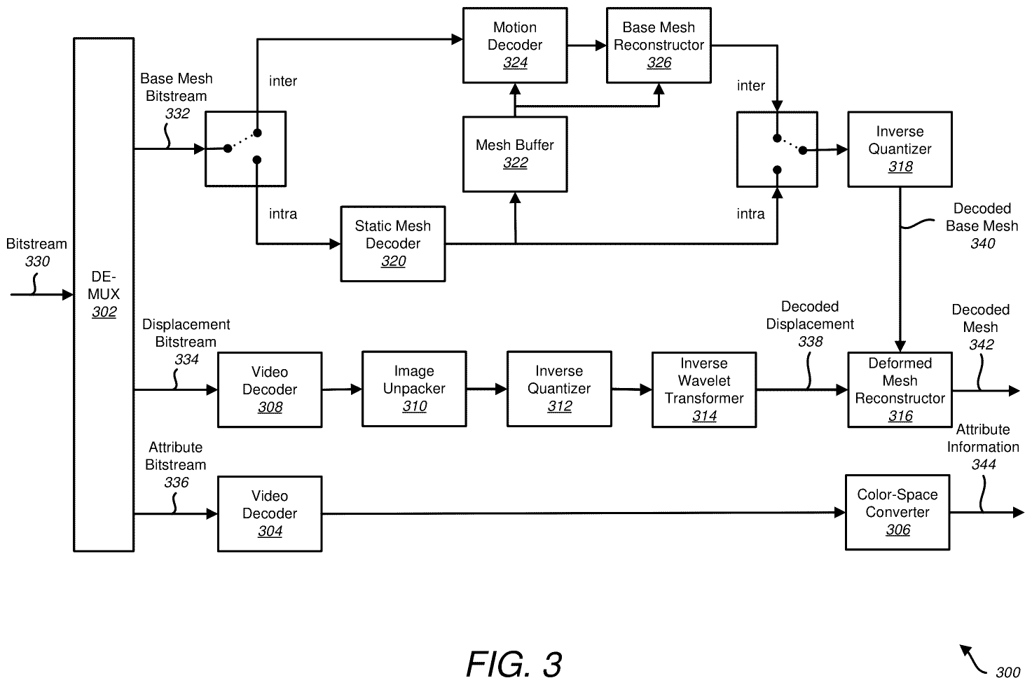

Attribute information 262 (e.g., color, texture, etc.) of the mesh frame may be encoded separately from the geometry information of the mesh frame described above. In some examples, attribute information 262 of the mesh frame may be represented (e.g., stored) by an attribute map (e.g., texture map) that associates each vertex of the mesh frame with corresponding attributes information of that vertex. Attribute transfer 232 may re-parameterize attribute information 262 in the attribute map based on reconstructed mesh determined (e.g., generated or output) from mesh reconstruction components 225. Mesh reconstruction components 225 perform inverse or decoding functions and may be the same or similar components in a decoder (e.g., decoder 300 of FIG. 3). For example, inverse quantizer 228 may inverse quantize reconstructed base mesh 256 to determine (e.g., generate or output) reconstructed base mesh 268. Video decoder 226, image unpacker 224, inverse quantizer 222, and inverse wavelet transformer 220 may perform the inverse functions as that of video encoder 216, image packer 214, quantizer 212, and wavelet transformer 210, respectively. Accordingly, reconstructed displacement 270, corresponding to displacement 258, may be generated from applying video decoder 226, image unpacker 224, inverse quantizer 222, and inverse wavelet transformer 220 in that order. Deformed mesh reconstructor 230 may determine the reconstructed mesh, corresponding to the input mesh frame, based on reconstructed base mesh 268 and reconstructed displacement 270. In some examples, the reconstructed mesh may be the same decoded mesh determined from the decoder based on decoding base mesh bitstream 254 and displacement bitstream 260.

Attribute information of the re-parameterized attribute map may be packed in images (e.g., 2D images or picture frames) by padding component 234. Padding component 234 may fill (e.g., pad) portions of the images that do not contain attribute information. In some examples, color-space converter 236 may translate (e.g., convert) the representation of color (e.g., an example of attribute information 262) from a first format to a second format (e.g., from RGB444 to YUV420) to achieve improved rate-distortion (RD) performance when encoding the attribute maps. In an example, color-space converter 236 may also perform chroma subsampling to further increase encoding performance. Finally, video encoder 240 encodes the images (e.g., pictures frames) representing attribute information 262 of the mesh frame to determine (e.g., generate or output) attribute bitstream 264 multiplexed by mux 218 into bitstream 266. In some examples, video encoder 240 may be an existing 2D video compression encoder such as an HEVC encoder or a VVC encoder.

FIG. 2B illustrates a block diagram of an example encoder 200B for inter encoding a 3D mesh, according to some embodiments. For example, an encoder (e.g., encoder 114) may comprise encoder 200B. As shown in FIG. 2B, encoder 200B comprises many of the same components as encoder 200A. In contrast to encoder 200A, encoder 200B does not include mesh encoder 204 and mesh decoder 206, which correspond to coders for static 3D meshes. Instead, encoder 200B comprises a motion encoder 242, a motion decoder 244, and a base mesh reconstructor 246. Motion encoder 242 may determine a motion field (e.g., one or more motion vectors (MVs)) that, when applied to a reconstructed quantized reference base mesh 243, best approximates base mesh 252.

The determined motion field may be encoded in bitstream 266 as motion bitstream 272. In some examples, the motion field (e.g., a motion vector in the x, y, and z directions) may be entropy coded as a codeword (e.g., for each directional component) resulting from a coding scheme such as a unary, a Golomb code (e.g., exp-Golomb code), a Rice code, or a combination thereof. In some examples, the codeword may be arithmetically coded, e.g., using CABAC. A prefix part of the codeword may be context coded and a suffix part of the coded may be bypass coded. In some examples, a sign bit for each directional component of the motion vector may be coded separately.

In some examples, motion bitstream 272 may further include indication of the selected reconstructed quantized reference base mesh 243.

In some examples, motion bitstream 272 may be decoded by motion decoder 244 and used by base mesh reconstructor 246 to generate reconstructed quantized base mesh 256. For example, base mesh reconstructor 246 may apply the decoded motion field to reconstructed quantized reference base mesh 243 to determine (e.g., generate) reconstructed quantized base mesh 256.

In some examples, a reconstructed quantized reference base mesh m′(j) associated with a reference mesh frame with index j may be used to predict the base mesh m(i) associated with the current frame with index i. Base meshes m(i) and m( ) may comprise the same: number of vertices, connectivity, texture coordinates, and texture connectivity. The positions of vertices may differ between base meshes m(i) and m(j).

In some examples, the motion field f(i) may be computed by considering the quantized version of m(i) and the reconstructed quantized base mesh m′(j). Base mesh m′(j) may have a different number of vertices than m(j) (e.g., vertices may have been merged or removed). Therefore, the encoder may track the transformation applied to m( ) to determine (e.g., generate or obtain) m′(j) and applies it to m(i). This transformation may enable a 1-to-1 correspondence between vertices of base mesh m′(j) and the transformed and quantized version of base mesh m(i), denoted as m\hat{ }*(i). The motion field f(i) may be computed by subtracting the quantized positions Pos(i,v) of the vertex v of m\hat{ }*(i) from the positions Pos(j,v) of the vertex v of m′(j) as follows: f(i,v)=Pos(j,v)−Pos(i,v). The motion field may be further predicted by using the connectivity information of base mesh m′(j) and the prediction residuals may be entropy encoded.

In some examples, since the motion field compression process may be lossy, a reconstructed motion field denoted as f′(i) may be computed by applying the motion decoder component. A reconstructed quantized base mesh m′(i) may then be computed by adding the motion field to the positions of vertices in base mesh m′(j). To better exploit temporal correlation in the displacement and attribute map videos, inter prediction may be enabled in the video encoder.

In some embodiments, an encoder (e.g., encoder 114) may comprise encoder 200A and encoder 200B.

FIG. 3 illustrates a diagram showing an example decoder 300. Bitstream 330, which may correspond to bitstream 266 in FIGS. 2A and 2B and may be received in a binary file, may be demultiplexed by de-mux 302 to separate bitstream 330 into base mesh bitstream 332, displacement bitstream 334, and attribute bitstream 336 carrying base mesh geometry information, displacement geometry information, and attribute information, respectively. Attribute bitstream 336 may include one or more attribute map sub-streams for each attribute type. In some examples, for inter decoding, the bitstream is de-multiplexed into separate sub-streams, including: a motion sub-stream, a displacement sub-stream for positions and potentially for each vertex attribute, zero or more attribute map sub-streams, and an atlas sub-stream containing patch information in the same manner as in V3C/V-PCC.

In some examples, base mesh bitstream 332 may be decoded in an intra mode or an inter mode. In the intra mode, static mesh decoder 320 may decode base mesh bitstream 332 (e.g., to generate reconstructed base mesh m′(i)) that is then inverse quantized by inverse quantizer 318 to determine (e.g., generate or output) decoded base mesh 340 (e.g., reconstructed quantized base mesh m″(i)). In some examples, static mesh decoder 320 may correspond to mesh decoder 206 of FIG. 2A.

In some examples, in the inter mode, base mesh bitstream 332 may include motion field information that is decoded by motion decoder 324. In some examples, motion decoder 324 may correspond to motion decoder 244 of FIG. 2B. For example, motion decoder 324 may entropy decode base mesh bitstream 332 to determine motion field information. In the inter mode, base mesh bitstream 332 may indicate a previous base mesh (e.g., reference base mesh m′(j)) decoded by static mesh decoder 320 and stored (e.g., buffered) in mesh buffer 322. Base mesh reconstructor 326 may generate a quantized reconstructed base mesh m′(i) by applying the decoded motion field (output by motion decoder 324) to the previously decoded (e.g., reconstructed) base mesh m′(j) stored in mesh buffer 322. In some examples, base mesh reconstructor 326 may correspond to base mesh reconstructor 246 of FIG. 2B. The quantized reconstructed base mesh may be inverse quantized by inverse quantizer 318 to determine (e.g., generate or output) decoded base mesh 340 (e.g., reconstructed base mesh m″(i)). In some examples, decoded base mesh 340 may be the same as reconstructed base mesh 268 in FIGS. 2A and 2B.

In some examples, decoder 300 includes video decoder 308, image unpacker 310, inverse quantizer, and inverse wavelet transformer 314 that determines (e.g., generates) decoded displacement 338 from displacement bitstream 334. Video decoder 308, image unpacker 310, inverse quantizer, and inverse wavelet transformer 314 correspond to video decoder 226, image unpacker 224, inverse quantizer 222, and inverse wavelet transformer 220, respectively, and perform the same or similar operations. For example, the picture frames (e.g., images) received in displacement bitstream 334 may be decoded by video decoder 308, the displacement information may be unpacked by image unpacker 310 from the decoded image, inverse quantized by inverse quantizer 312 to determined inverse quantized wavelet coefficients representing encoded displacement information. Then, the unquantized wavelet coefficients may be inverse transformed by inverse wavelet transformer 314 to determine decoded displacement d″(i). In other words decoded displacement 338 (e.g., decoded displacement field d″(i)) may be the same as reconstructed displacement 270 in FIGS. 2A and 2B.

Deformed mesh reconstructor 316, which corresponds to deformed mesh reconstructor 230, may determine (e.g., generate or output) decoded mesh 342 (M″(i)) based on decoded displacement 338 and decoded base mesh 340. For example, deformed mesh reconstructor 316 may combine (e.g., add) decoded displacement 338 to a subdivided decoded mesh 340 to determine decoded mesh 342.

In some examples, decoder 300 includes video decoder 304 that decodes attribute bitstream 336 comprising encoded attribute information represented (e.g., stored) in 2D images (or picture frames) to determined attribute information 344 (e.g., decoded attribute information or reconstructed attribute information). In some examples, video decoder 304 may be an existing 2D video compression decoder such as an HEVC decoder or a VVC decoder. Decoder 300 may include a color-space converter 306, which may revert the color format transformation performed by color-space converter 236 in FIGS. 2A and 2B.

FIG. 4 is a diagram 400 showing an example process (e.g., a pre-processing operations) for generating displacements 414 of an input mesh 430 (e.g., an input 3D mesh frame) to be encoded, according to some embodiments. In some examples, displacements 414 may correspond to displacement 258 shown in FIG. 2A and FIG. 2B.

In diagram 400, a mesh decimator 402 determines (e.g., generates or outputs) an initial base mesh 432 based on (e.g., using) input mesh 430. In some examples, the initial base mesh 432 may be determined (e.g., generated) from the input mesh 432 through a decimation process. In the decimation process, the mesh topology of the mesh frame may be reduced to determine the initial base mesh (which may be referred to as a decimated mesh or decimated base mesh). As will be illustrated in FIG. 5, the decimation process may involve a down sampling process to remove vertices from the input mesh 432 so that a small portion (e.g., 6% or less) of the vertices in the input mesh 430 may remain in the initial base mesh 432.

Mesh subdivider 404 applies a subdivision scheme to generate initial subdivided mesh 434. As will be discussed in more detail with regard to FIG. 5, the subdivision scheme may involve upsampling the initial base mesh 432 to add more vertices to the 3D mesh based on the topology and shape of the original mesh to generate the initial subdivided mesh 434.

Fitting component 406 may fit the initial subdivided mesh to determine a deformed mesh 436 that may more closely approximate the surface of input mesh 430. As will be discussed in more detail with respect to FIG. 5, the fitting may be performed by moving vertices of the initial subdivided mesh 434 towards the surfaces of the input mesh 430 so that the subdivided mesh 434 can be used to approximate the input mesh 430. In some implementations, the fitting is performed by moving each vertex of the initial subdivided mesh 434 along the normal direction of the vertex until the vertex intersects with a surface of the input mesh 430. The resulting mesh is the deformed mesh 436. The normal direction may be indicated by a vertex normal at the vertex, which may be obtained from face normals of triangles formed by the vertex.

Base mesh generator 408 may perform another fitting process to generate a base mesh 438 from the initial base mesh 432. For example, the base mesh generator 408 may deform the initial base mesh 432 according to the deformed mesh 436 so that the initial base mesh 432 is close to the deformed mesh 436. In some implementations, the fitting process may be performed in a similar manner to the fitting component 406. For example, the base mesh generator 408 may move each of the vertices in the initial base mesh 432 along its normal direction (e.g., based on the vertex normal at each vertex) until the vertex reaches a surface of the deformed mesh 436. The output of this process is the base mesh 438.

Base mesh 438 may be output to a mesh reconstruction process 410 to generate a reconstructed base mesh 440. Reconstructed base mesh 440 may be subdivided by mesh subdivider 418 and the subdivided mesh 442 may be input to displacement generator 420 to generate (e.g., determine or output) displacement 414, as further described below with respect to FIG. 5. In some examples, mesh subdivider 418 may apply the same subdivision scheme as that applied by mesh subdivider 404. In these examples, vertices in the subdivided mesh 442 have a one-to-one correspondence with the vertices in the deformed mesh 436. As such, the displacement generator 420 may generate the displacements 414 by calculating the difference between each vertex of the subdivided mesh 442 and the corresponding vertex of the deformed mesh 436. In some implementations, the difference may be projected onto a normal direction of the associated vertex and the resulting vector is the displacement 414. In this way, only the sign and magnitude of the displacement 414 need to be encoded in the bitstream, thereby increasing the coding efficiency. In addition, because the base mesh 438 has been fitted toward the deformed mesh 436, the displacements 414 between the deformed mesh 436 and the subdivided mesh 442 (generated from the reconstructed base mesh 440) will have small magnitudes, which further reduces the payload and increases the coding efficiency.

In some examples, one advantage of applying the subdivision process is to allow for more efficient compression, while offering a faithful approximation of the original input mesh 430 (e.g., surface or curve of the original input mesh 430). The compression efficiency may be obtained because the base mesh (e.g., decimated mesh) has a lower number of vertices compared to the number of vertices of input mesh 430 and thus requires a fewer number of bits to be encoded and transmitted. Additionally, the subdivided mesh may be automatically generated by the decoder once the base mesh has been decoded without any information needed from the encoder other than a subdivision scheme (e.g., subdivision algorithm) and parameters for the subdivision (e.g., a subdivision iteration count). The reconstructed mesh may be determined by decoding displacement information (e.g., displacement vectors) associated with vertices of the subdivided mesh (e.g., subdivided curves/surfaces of the base mesh). Not only does the subdivision process allow for spatial/quality scalability, but also the displacements may be efficiently coded using wavelet transforms (e.g., wavelet decomposition), which further increases compression performance.

In some embodiments, mesh reconstruction process 410 includes components for encoding and then decoding base mesh 438. FIG. 4 shows an example for the intra mode, in which mesh reconstruction process 410 may include quantizer 411, static mesh encoder 412, static mesh decoder 413, and inverse quantizer 416, which may perform the same or similar operations as quantizer 202, mesh encoder 204, mesh decoder 206, and inverse quantizer 228, respectively, from FIG. 2A. In the inter mode, mesh reconstruction process 410 may include quantizer 202, motion encoder 242, motion decoder 244, base mesh reconstructor 246, and inverse quantizer 228.

FIG. 5 illustrates an example process for approximating and encoding a geometry of a 3D mesh, according to some embodiments. For illustrative purposes, the 3D mesh is shown as 2D curves. An original surface 510 of the 3D mesh (e.g., a mesh frame) includes vertices (e.g., points) and edges that connect neighboring vertices. For example, point 512 and point 513 are connected by an edge corresponding to surface 514.

In some examples, a decimation process (e.g., a down-sampling process or a decimation/down-sampling scheme) may be applied to an original surface 510 of the original mesh to generate a down-sampled surface 520 of a decimated (or down-sampled) mesh. In the context of mesh compression, decimation refers to the process of reducing the number of vertices in a mesh while preserving its overall shape and topology. For example, original mesh surface 510 is decimated into a surface 520 with fewer samples (e.g., vertices and edges) but still retains the main features and shape of the original mesh surface 510. This down-sampled surface 520 may correspond to a surface of the base mesh (e.g., a decimated mesh).

In some examples, after the decimation process, a subdivision process (e.g., subdivision scheme or subdivision algorithm) may be applied to down-sampled surface 520 to generate an up-sampled surface 530 with more samples (e.g., vertices and edges). Up-sampled surface 530 may be part of the subdivided mesh (e.g., subdivided base mesh) resulting from subdividing down-sampled surface 520 corresponding to a base mesh.

Subdivision is a process that is commonly used after decimation in mesh compression to improve the visual quality of the compressed mesh. The subdivision process involves adding new vertices and faces to the mesh based on the topology and shape of the original mesh. In some examples, the subdivision process starts by taking the reduced mesh that was generated by the decimation process and iteratively adding new vertices and edges. For example, the subdivision process may comprise dividing each edge (or face) of the reduced/decimated mesh into shorter edges (or smaller faces) and creating new vertices at the points of division. These new vertices are then connected to form new faces (e.g., triangles, quadrilaterals, or another polygon). By applying subdivision after the decimation process, a higher level of compression can be achieved without significant loss of visual fidelity. Various subdivision schemes may be used such as, e.g., mid-point, Catmull-Clark subdivision, Butterfly subdivision, Loop subdivision, etc., or a combination thereof.

For example, FIG. 5 illustrates an example of the mid-point subdivision scheme. In this scheme, each subdivision iteration subdivides each triangle into four sub-triangles. New vertices are introduced in the middle of each edge. The subdivision process may be applied independently to the geometry and to the texture coordinates since the connectivity for the geometry and for the texture coordinates are usually different. The subdivision scheme computes the position Pos(v₁₂) of a newly introduced vertex v₁₂ at the center or middle of an edge (v₁, v₂) formed by a first vertex (v₁) and a second vertex (v₂), as follows:

$$Pos ( {v}_{12} ) = \frac{1}{2} ( Pos ( {v}_{1} ) + Pos ( {v}_{2} ) ) ,$$

where Pos(v₁) and Pos(v₂) are the positions of the vertices v₁ and v₂. In some examples, the same process may be used to compute the texture coordinates of the newly created vertex. For normal vectors, a normalization step may be applied as follows:

$$N ( {v}_{12} ) = \frac{N ( {v}_{1} ) + N ( {v}_{2} )}{‖ N ( {v}_{1} ) + N ( {v}_{2} ) ‖} ,$$

N(v₁₂), N(v₁), and N(v₂) are the normal vectors associated with the vertices v₁₂, v₁, and v₂, respectively. ∥x∥ is the norm2 of the vector x.

Using the mid-point subdivision scheme, as shown in up-sampled surface 530, point 531 may be generated as the mid-point of edge 522 which is an edge connecting point 532 and point 533. Point 531 may be added as a new vertex. Edge 534 and edge 542 are also added to connect the added new vertex corresponding to point 531. In some examples, the original edge 522 may be replaced by two new edges 534 and 542.

In some examples, down-sampled surface 520 may be iteratively subdivided to generate up-sampled surface 530. For example, a first subdivided mesh resulting from a first iteration of subdivision applied to down-sampled surface 520 may be further subdivided according to the subdivision scheme to generate a second subdivided mesh, etc. In some examples, a number of iterations corresponding to levels of subdivision may be predetermined. In other examples, an encoder may indicate the number of iterations to a decoder, which may similarly generate a subdivided mesh, as further described above.

In some embodiments, the subdivided mesh may be deformed towards (e.g., approximates) the original mesh to determine (e.g., get or obtain) a prediction of the original mesh having original surface 510. The points on the subdivided mesh may be moved along a computed normal orientation until it reaches an original surface 510 of the original mesh. The distance between the intersected point on the original surface 510 and the subdivided point may be computed as a displacement (e.g., a displacement vector). For example, point 531 may be moved towards the original surface 510 along a computed normal orientation of surface (e.g., represented by edge 542). When point 531 intersects with surface 514 of the original surface 510 (of original/input mesh), a displacement vector 548 can be computed. Displacement vector 548 applied to point 531 may result in displaced surface 540, which may better approximate original surface 510. In some examples, displacement information (e.g., displacement vector 548) for vertices of the subdivided mesh (e.g., up-sampled surface 530 of subdivided mesh) may be encoded and transmitted in displacement bitstream 260 shown in examples encoders of FIGS. 2A and 2B. Note, as explained with respect to FIG. 4, the subdivided mesh corresponding to up-sampled surface may be subdivided mesh 442 that is compared to deformed mesh 436 representative of original surface 510 of the input mesh.

In some embodiments, displacements d(i) (e.g., a displacement field or displacement vectors) may be computed and/or stored based on local coordinates or global coordinates. For example, a global coordinate system is a system of reference that is used to define the position and orientation of objects or points in a 3D space. It provides a fixed frame of reference that is independent of the objects or points being described. The origin of the global coordinate system may be defined as the point where the three axes intersect. Any point in 3D space can be located by specifying its position relative to the origin along the three axes using Cartesian coordinates (x, y, z). For example, the displacements may be defined in the same cartesian coordinate system as the input or original mesh. Accordingly, a displacement may comprise three components (in the x, y, and z directions).

In a local coordinate system, a normal, a tangent, and/or a binormal vector (which are mutually perpendicular) may be determined that defines a local basis for the 3D space to represent the orientation and position of an object in space relative to a reference frame. In some examples, displacement field d(i) may be transformed from the canonical coordinate system to the local coordinate system, e.g., defined by a normal to the subdivided mesh at each vertex (e.g., commonly referred to as a vertex normal). The normal at each vertex may be obtained from combining the face normals of triangles formed by the vertex. In some examples, using the local coordinate system may enable further compression of tangential components of the displacements compared to the normal component. For example, the displacements may be signaled as a scalar value (e.g., including a sign and a magnitude) which may be used to derive a displacement vector based on the normal at the vertex. For example, the displacement vector may be determined as a product of the scalar value and a normalized normal vector (e.g., unit normal vector) at the vertex. Accordingly, using local coordinate system, displacements need not be signaled as three components corresponding to the directions of the canonical coordinate system.

In some embodiments, a decoder (e.g., decoder 300 of FIG. 3) may receive and decode a base mesh corresponding to (e.g., having) down-sampled surface 520. Similar to the encoder, the decoder may apply a subdivision scheme to determine a subdivided mesh having up-sampled surface 530 generated from down-sampled surface 520. The decoder may receive and decode displacement information including displacement vector 548 and determine a decoded mesh (e.g., reconstructed mesh) based on the subdivided mesh (corresponding to up-sampled surface 530) and the decoded displacement information. For example, the decoder may add the displacement at each vertex with a position of the corresponding vertex in the subdivided mesh. The decoder may obtain a reconstructed 3D mesh by combining the obtained/decoded displacements with positions of vertices of the subdivided mesh.

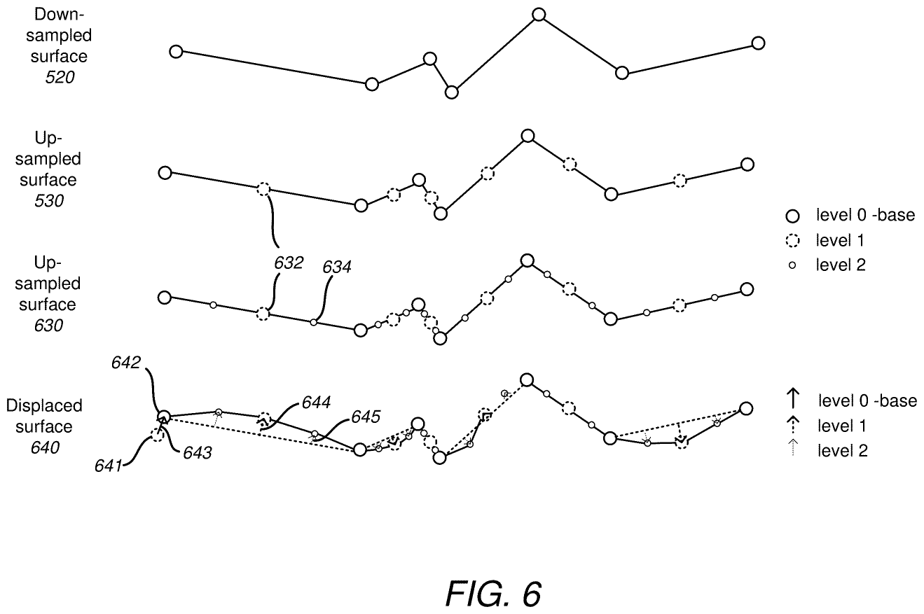

FIG. 6 illustrates an example of vertices of a subdivided mesh (e.g., a subdivided base mesh) corresponding to multiple levels of detail (LODs), according to some embodiments. As described above with respect to FIG. 5, the subdivision process (e.g., subdivision scheme) may be an iterative process, in which a mesh can be subdivided multiple times and a hierarchical data structure is generated containing multiple levels. Each level of the hierarchical data structure may include different numbers of data samples (e.g., vertices and edges in mesh) representing (e.g., forming) different density/resolution (e.g., also referred to as levels of details (LoDs)). For example, a down-sampled surface 520 (of a decimated mesh) can be subdivided into up-sampled surface 530 after a first iteration of subdivision. Up-sampled surface 530 may be further subdivided into up-sampled surface 630 and so forth. In this case, vertices of the mesh with down-sampled surface 520 may be considered as being in or associated with LOD0. Vertices, such as vertex 632, generated in up-sampled surface 530 after a first iteration of subdivision may be at LOD1. Vertices, such as vertex 634, generated in up-sampled surface 630 after another iteration of subdivision may be at LOD2, etc. In some examples, an LOD0 may refer to the vertices resulting from decimation of an input (e.g., original) mesh resulting in a base mesh with (e.g., having) down-sampled surface 520. For example, vertices at LOD0 may be vertices of a reconstructed quantized base mesh 256 of FIGS. 2A-B, reconstructed/decoded base mesh 340 of FIG. 3, reconstructed base mesh 440 of FIG. 4.

In some examples, the computation of displacements in different LODs follows the same mechanism as described above with respect to FIG. 5. In some examples, a displacement vector 643 may be computed from a position of a vertex 641 in the original surface 510 (of original mesh) to a vertex 642, from displace surface 640 of the deformed mesh, at LOD0. The displacement vectors 644 and 645 of corresponding vertices 632 and 634 from LOD1 and LOD 2, respectively, may be similarly calculated. Accordingly, in some examples, a number of iterations of subdivision may correspond to a number of LODs and one of the iterations may correspond to one LOD of the LODs.

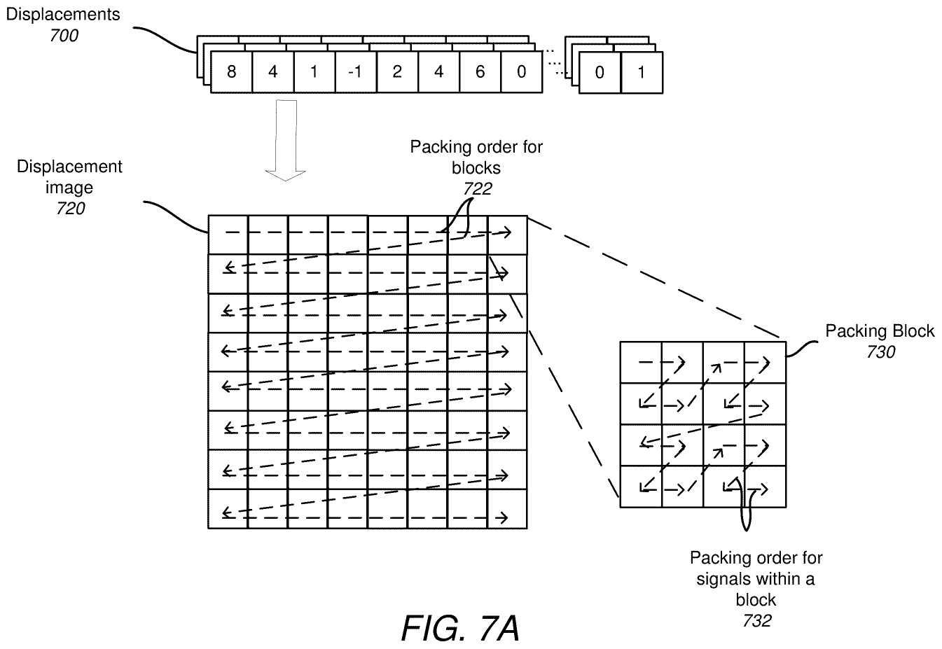

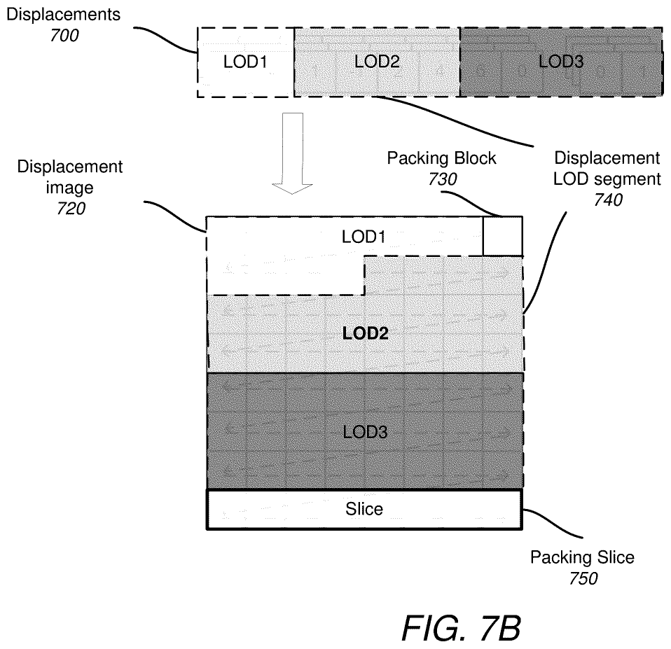

FIG. 7A illustrates an example of an image 720 (e.g., picture or a picture frame) packed with displacements 700 (e.g., displacement fields or vectors) using a packing scheme (e.g., a packing scheme or a packing algorithm), according to some embodiments. Specifically, displacements 700 may be generated, as described above with respect to FIG. 5 and FIG. 6, and packed into 2D images. In some examples, a displacement can be a 3D vector containing the values for the three components of the distance. For example, a delta x value represents the shift on the x-axis from a point A to a point B in a Cartesian coordinate system. In some examples, a displacement vector may be represented by less than three components, e.g., by one or two components. For example, when a local coordinate system is used to store the displacement value, one component with the highest significance may be stored as being representative of the displacement and the other components may be discarded.

In some examples, as will be further described below, a displacement value may be transformed into other signal domains for achieving better compression. For example, a displacement can be wavelet transformed and be decomposed into and represented as wavelet coefficients (e.g., coefficient values or transform coefficients). In these examples, displacements 700 that are packed in image 720 may comprise the resulting wavelet coefficients (e.g., transform coefficients), which may be more efficiently compressed than the un-transformed displacement values. At the decoder side, a decoder may decode displacements 700 as wavelet coefficients and may apply an inverse wavelet transform process to reconstruct the original displacement values obtained at the encoder.

In some examples, one or more of displacements 700 may be quantized by the encoder before being packed into displacement image 720. In some examples, one or more displacements may be quantized before being wavelet transformed, after being wavelet transformed, or quantized before and after being wavelet transformed. For example, FIG. 7A shows quantized wavelet transform values 8, 4, 1, −1, etc. in displacements 700. At the decoder side, the decoder may perform inverse quantization to reverse or undo the quantization process performed by the encoder.

In general, quantization in signal processing may be the process of mapping input values from a larger set to output values in a smaller set. It is often used in data compression to reduce the amount, the precision, or the resolution of the data into a more compact representation. However, this reduction can lead to a loss of information and introduce compression artifacts. The choice of quantization parameters, such as the number of quantization levels, is a trade-off between the desired level of precision and the resulting data size. There are many different quantization techniques, such as uniform quantization, non-uniform quantization, and adaptive quantization that may be selected/enabled/applied. They can be employed depending on the specific requirements of the application.

In some examples, wavelet coefficients (e.g., displacement coefficients representing displacement signals) may be adaptively quantized according to LODs. As explained above, a mesh may be iteratively subdivided to generate a hierarchical data structure comprising multiple LODs. In this example, each vertex and its associated displacement belong to the same level of hierarchy in the LOD structure, e.g., an LOD corresponding to a subdivision iteration in which that vertex was generated. In some examples, a vertex at each LOD may be quantized according to corresponding quantization parameters that specify different levels of intensity/precision of the signal to be quantized. For example, wavelet coefficients in LOD 3 may have a quantization parameter with, e.g., 42 and wavelet coefficients in LOD 0 may have a different, smaller quantization parameter of 28 to preserve more detail information in LOD 0.

In some examples, displacements 700 may be packed onto the pixels in a displacement image 720 with a width W and a height H. In an example, a size of displacement image 720 (e.g., W multiplied by H) may be greater or equal to the number of components in displacements 700 to ensure all displacement information may be packed. In some examples, displacement image 720 may be further partitioned into smaller regions (e.g., squares) referred to as a packing block 730. In an example, the length of packing block 730 may be an integer multiple of 2.

The displacements 700 (e.g., displacement signals represented by quantized wavelet coefficients) may be packed into a packing block 730 according to a packing order 732. Each packing block 730 may be packed (e.g., arranged or stored) in displacement image 720 according to a packing order 722. Once all the displacements 700 are packed, the empty pixels in image 720 may be padded with neighboring pixel values for improved compression. In the example shown in FIG. 7A, packing order 722 for packing blocks may be a raster order and a packing order 732 for displacements within packing block 730 may be, for example, a Z-order. However, it should be understood that other packing schemes both for blocks and displacements within blocks may be used. In some embodiments, a packing scheme for the blocks and/or within the blocks may be predetermined. In some embodiments, the packing scheme may be signaled by the encoder in the bitstream per patch, patch group, tile, image, or sequence of images. Relatedly, the signaled packing scheme may be obtained by the decoder from the bitstream.

In some examples, packing order 722 may be identical to the packing order 732. They can be signaled or represented by a single packing order using either of the signal. For example, packing order 732 may be derived or inherited from packing order 722 signal if they are identical.

In some examples, packing order 732 may follow a space-filling curve, which specifies a traversal in space in a continuous, non-repeating way. Some examples of space-filling curve algorithms (e.g., schemes) include Z-order curve, Hilbert Curve, Peano Curve, Moore Curve, Sierpinski Curve, Dragon Curve, etc. Space-filling curves have been used in image packing techniques to efficiently store and retrieve images in a way that maximizes storage space and minimizes retrieval time. Space-filling curves are well-suited to this task because they can provide a one-dimensional representation of a two-dimensional image. One common image packing technique that uses space-filling curves is called the Z-order or Morton order. The Z-order curve is constructed by interleaving the binary representations of the x and y coordinates of each pixel in an image. This creates a one-dimensional representation of the image that can be stored in a linear array. To use the Z-order curve for image packing, the image is first divided into small blocks, typically 8×8 or 16×16 or 64×64 pixels in size. Each block is then encoded using the Z-order curve and stored in a linear array. When the image needs to be retrieved, the blocks are decoded using the inverse Z-order curve and reassembled into the original image.

In some examples, once packed, displacement image 720 may be encoded and decoded using a conventional 2D video codec.

In some examples, once packed, displacement image 720 may be encoded and decoded using an arithmetic codec.

In some examples, partial information of the displacement may be encoded and decoded. For example, only the normal component of a displacement computed from a local coordinate system associated with each vertex may be signaled instead of transmitting all three. For example, displacement associated with a subset of vertices may be skipped in signaling for extra saving of the bitstream.

In some examples, an indication may be signaled to indicate the skipping of partial information of the displacement being encoded and decoded. In some examples, the indication may be associated with a subset of vertices, for example, the LODs.

FIG. 7B illustrates an example of packed displacement image 720, according to some embodiments. As shown, displacements 700 packed in displacement image 720 may be ordered according to their LODs. For example, displacement coefficients (e.g., quantized wavelet coefficients) may be ordered from a lowest LOD (e.g., LOD 0) to a highest LOD (e.g., LOD 2). In other words, a wavelet coefficient representing a displacement for a vertex at a first LOD may be packed (e.g., arranged and stored in displacement image 720) according to the first LOD. For example, displacements 700 may be packed from a lowest LOD to a highest LOD. Higher LODs represent a higher density of vertices and corresponds to more displacements compared to lower LODs. The portion of displacement image 720 not in any LOD may be a padded portion.

In some examples, displacements may be packed in inverse order from highest LOD to lowest LOD. In an example, the encoder may signal whether displacements are packed from lowest to highest LOD or from highest to lowest LOD.

In some examples, displacements may be packed in inverse order from the ending pixel of an image or within a subset of the image (e.g., slice, tile, or packed pixels such as LOD segment 740) instead of from the beginning. For example, instead of packing from the left upper corner towards the right bottom corner, the pixels representing the displacements are packing from the right bottom corner towards the left upper corner.

In some examples, displacements in an LOD may contain padded zero-value pixels so they can be processed as an individual encoding/decoding unit. (e.g., a block, a slice, a tile, etc.) For example, a packed displacement image 720 may consist of a single tile/slice 750 or multiple packing tiles/slices that contains a single segment 740 or multiple LOD segments. Each LOD segment may contain a single block 730 or multiple blocks.

In some examples, a wavelet transform may be applied to displacement values to generate wavelet coefficients (e.g., displacement coefficients), representing displacement signals, that may be more easily compressed. Wavelet transforms are commonly used in signal processing to decompose a signal into a set of wavelets, which are small wave-like functions allowing them to capture localized features in the signal. The result of the wavelet transform is a set of coefficients that represent the contribution of each wavelet at different scales and positions in the signal. It is useful for detecting and localizing transient features in a signal and is generally used for signal analysis and data compression such as image, video, and audio compression.

Taking a 2D image as an example, a wavelet transform is used to decompose an image (signals) into two discrete components, known as predictions (e.g., also referred to as approximations) and details. The decomposed signals are further divided into a high frequency component (details) and a low frequency component (approximations/predictions) by passing through two filters, high and low pass filters. In the example of the 2D image, two filtering stages, a horizontal and a vertical filtering, are applied to the image signals. A down-sampling step is also required after each filtering stage on the decomposed components to obtain the wavelet coefficients resulting in four sub-signals in each decomposition level. The high frequency component corresponds to rapid changes or sharp transitions in the signal, such as an edge or a line in the image. On the other hand, the low frequency component refers to global characteristics of the signal. Depending on the application, different filtering and compression can be achieved. There are various types of wavelets such as Haar, Daubechies, Symlets, etc., each with different properties such as frequency resolution, time localization, etc.

In signal processing, a lifting scheme is a technique for both designing wavelets and performing the discrete wavelet transform (DWT). It is an alternative approach to the traditional filter bank implementation of the DWT that offers several advantages in terms of computational efficiency and flexibility. It decomposes the signal using a series of lifting steps such that the input signal, e.g., representing displacements for 3D meshes, may be converted to displacement coefficients in-place. In the lifting scheme, a series of lifting operations (e.g. lifting steps) may be performed. Each lifting operation involves a prediction step (e.g., prediction operation) and an update step (e.g., update operation). These lifting operations may be applied iteratively to obtain the wavelet coefficients.

In some examples, displacements for 3D mesh frames may be transformed using a wavelet transform with lifting, e.g., referred to as a lifting scheme. Specifically, the wavelet transform may “split” the input signal (e.g., a displacement signal) into two signals: the even-samples signal E and the odd-sample O signal. The even samples E may comprise two displacement signals E₁ and E₂ associated with two vertices that are considered to be on an edge of the vertex associated with the input displacement signal. The odd sample O may represent the original input signal. As explained above, the edge information may be determined (e.g., generated or received) from the subdivision scheme applied to each mesh frame of the 3D mesh. A prediction of the odd-sample O signal may be determined based on a weighted sum of the even-samples signal E. Then, the odd-sample O signal may be encoded as a difference between the odd-sample O signal. Further, each of the even-sample signals E₁ and E₂ may be adjusted based on the difference weighted by an updated weight, which may be associated with the odd-sample O signal (e.g., associated with an LOD of the odd-sample O signal).

In some embodiments, wavelet coefficients (e.g., transformed wavelet coefficients) representing displacements corresponding to vertices of 3D mesh geometry may be quantized according to a quantization parameter that is set for each LOD of a plurality of LODs. The vertices may be at (e.g., generated) across the plurality of LODs. Further, wavelet coefficients within each LOD may be quantized with a dead-zone quantizer. The dead-zone quantizer may be a type of quantizer with symmetric behavior around a quantized value of 0 and reaches its peak value at zero. The region around the 0 output value of such a quantizer is referred to as the dead zone. The dead zone may be configured with a different width than that for the other quantization steps of the quantizer. The dead-zone quantizer may be a uniform quantizer such that the other quantization steps besides the dead zone have uniform width (e.g., quantization size). In other words, with the dead-zone quantizer being set to a same size as the quantization step, each quantization step of the dead-zone quantizer is the same or uniform.

In some examples, wavelet coefficients of vertices at different LODs may be quantized (and inverse quantized) according to their corresponding LODs, which specify different levels of intensity (e.g., precision) or a signal to be scaled. For example, wavelet coefficients of vertices in LOD 3 may have a quantization scaling factor of, e.g., ⅛ and wavelet coefficients of vertices in LOD 0 may have a different, greater quantization scaling factor value of, e.g., 1 to preserve more detail information in LOD 0 (e.g., such that wavelet coefficients at higher LODs are quantized by a larger quantization step). Relatedly, the inverse scaling factors may be, e.g., 8 associated with LOD 3 and, e.g., 1 associated with LOD 0.

In existing technologies, as described above with respect to FIG. 7A, an image packer/unpacker applies a Z-order (e.g., Morton Code) as a space filling curve to fill the displacements (e.g., the transformed wavelet coefficients representing the displacements) into the image pixels in a region of an image. By exploiting the existing video compression technologies, the packed image of the displacements can be efficiently coded. However, this locality of the pixels representing the packed displacement may not be optimal.

Embodiments of the present disclosure are related to selecting parameters for packing/unpacking (e.g., packing at the encoder and unpacking at the decoder) the quantized wavelet coefficients representing displacements of vertices of a 3D mesh (e.g., a mesh frame). In some examples, a decoder may decode, from a bitstream, a displacement image comprising quantized wavelet coefficients representing displacements of vertices from a set of the vertices. Packing/unpacking information indicating an unpacking scheme and/or unpacking parameters associated with a subset of vertices of the set of vertices may be decoded from the bitstream. Then, a wavelet coefficient may be unpacked from the decoded displacement image as the displacement of a vertex in the subset of vertices, based on the unpacking scheme being associated with the subset in which the vertex belongs.

In some embodiments, to optimize the locality of the packed image pixels representing the displacements, the packing and unpacking information may contain multiple packing/unpacking schemes (indications) based on space filling curve. For example, the decoder may decode, from the bitstream, a packed image with transformed-quantized wavelet coefficients associated with a subset of vertices of displacements. The packing and unpacking information indicating multiple packing/unpacking schemes based on space filling curve may be decoded from the bitstream. Then, an image pixel (representing a transformed-quantized wavelet coefficients) may be determined as a displacement of the vertex. By applying one or multiple or a combination of multiple packing schemes based on space filling curve for a subset of vertices, better locality of the pixels on an image is preserved and the image may be compressed more efficiently.

By enabling different regions of the images to be packed/unpacked with displacements according to a plurality of parameters (e.g., packing block size, packing order, width of the packing image) for packing the displacement signals, the encoder may select specific parameters to pack the displacements to improve video decoding performance of the images. For example, if the packing image is packed with a different space filling curve, the pixels representing the packed displacement may be more localized to a specific region, for example, the center of a rectangular block instead of spread-out line by line when using z-order. This may be beneficial for video codec to find a more appropriate neighboring prediction pixel for a current pixel since they are closer in terms of their pixel distance. With a shorter pixel distance, the video codec is more likely to find a better predictor for that pixel. In this case, by applying a packing scheme that is more optimal for the video codec, more compression of displacements can be achieved.

In some embodiments, the packing and unpacking scheme may include traversal information that indicates a scheme of computing the traversal scheme within a packing block for the image pixels in the packing block. For example, the image may comprise a plurality of packing blocks in which displacement signals (e.g., represented as transformed wavelet coefficients) may be packed (e.g., placed). For example, the decoder may receive the traversal scheme or code for a space filling curve (e.g., Morton order or Z-order) to traverse and map a displacement value with 1D index A to a 2D image space with coordinate (X, Y), based on the vertex being in the subset. Then, the decoder may use the mapping to decode the 1D displacement value from the 2D image applied to an quantized transformed displacement value.

In some embodiments, the packing and unpacking scheme may include traversal information that indicates a scheme of computing the traversal origin within a packing block for the image pixels in the packing block. For example, the decoder may receive the traversal origin of a traversal scheme (e.g., left upper corner) to indicate where to start mapping a displacement value to a 2D image space with coordinate (X, Y), based on the vertex being in the subset. Then, the decoder may use the mapping to decode the 1D displacement value from the 2D image applied to an quantized transformed displacement value.

In some embodiments, the packing and unpacking scheme may include traversal information that indicates a scheme of computing the traversal orientation within a packing block for the image pixels in the packing block. For example, the decoder may receive the traversal orientation of a traversal scheme (e.g., left upper corner) to indicate whether the traversal is vertical or horizontal to map a displacement value to a 2D image space with coordinate (X, Y), based on the vertex being in the subset. Then, the decoder may use the mapping to decode the 1D displacement value from the 2D image applied to an quantized transformed displacement value.

In some embodiments, the packing and unpacking scheme may include traversal information that indicates a scheme of computing the traversal order within a packing block for the image pixels in the packing block. For example, the decoder may receive the traversal order of a traversal scheme (e.g., left upper corner) to indicate whether the traversal is in normal or inverse order to map a displacement value to a 2D image space with coordinate (X, Y), based on the vertex being in the subset. Then, the decoder may use the mapping to decode the 1D displacement value from the 2D image applied to an quantized transformed displacement value.

In some examples, the scheme of computing the traversal order may be identical to the scheme of computing the traversal origin.

In some embodiments, the packing and unpacking process are identical in terms of computing the traversal order or code for the space filling curve determined by the packing scheme. For example, the encoder and decoder may have identical output for a displacement signal index 1 using Z-order as a pixel coordinate in (x, y) space as (1,0). The difference is that the encoder writes the displacement value into the pixel space while the decoder reads the displacement value from the pixel space.

In some embodiments, the packing scheme may be applied to a sequence of frames for the sub-mesh or the 3D mesh. For example, the decoder may determine, based on the vertex being in the subset, the displacement packing scheme used for the frames in that sequence of the sub-mesh or the 3D mesh.

In some examples, the set of vertices includes non-overlapping subsets of vertices, and the packing information may be signaled (e.g., decoded) for each subset. For example, the subset may include vertices of the same LOD of LODs. In this example, packing scheme may be determined based on the packing information signaled per LOD. In other examples, the subset may include vertices associated with a packing block of the packing image, a sub-mesh of the 3D mesh, a patch group of the sub-mesh or the 3D mesh, a patch of the patch group, a slice/tile of the packing image, a frame of the sub-mesh or the 3D mesh, or a sequence of frames.

In some examples, an indication (e.g., a mode indication, a flag, a syntax element) of packing scheme adjustment (unpacking scheme adjustment on decoder side is also referred to packing scheme adjustment for simplicity) is enabled is decoded for the subset of vertices. The decoder may further decode the traversal information indicating the packing scheme based on the indication that packing scheme is enabled.

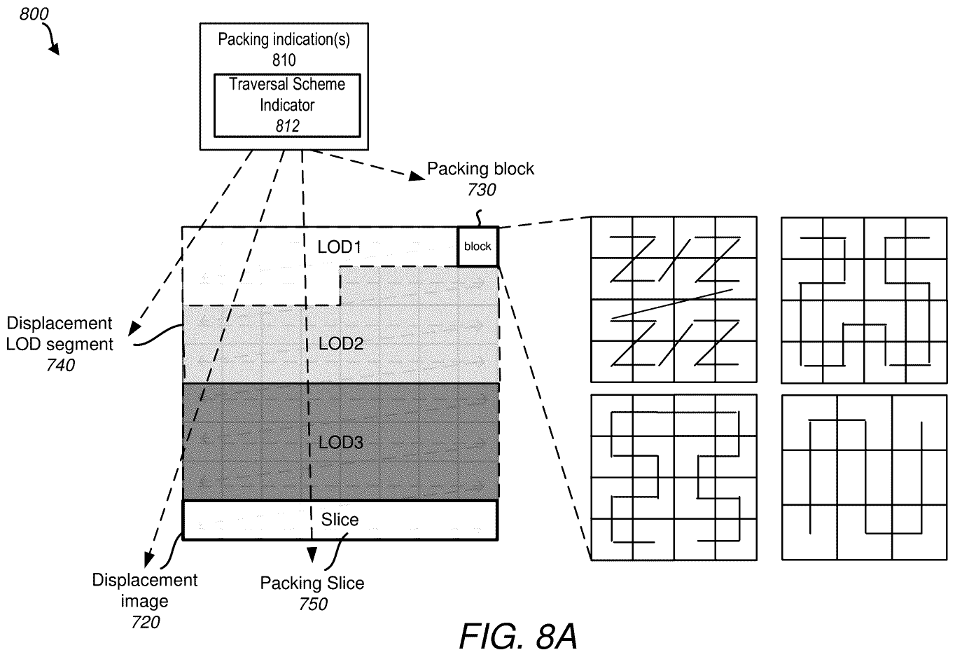

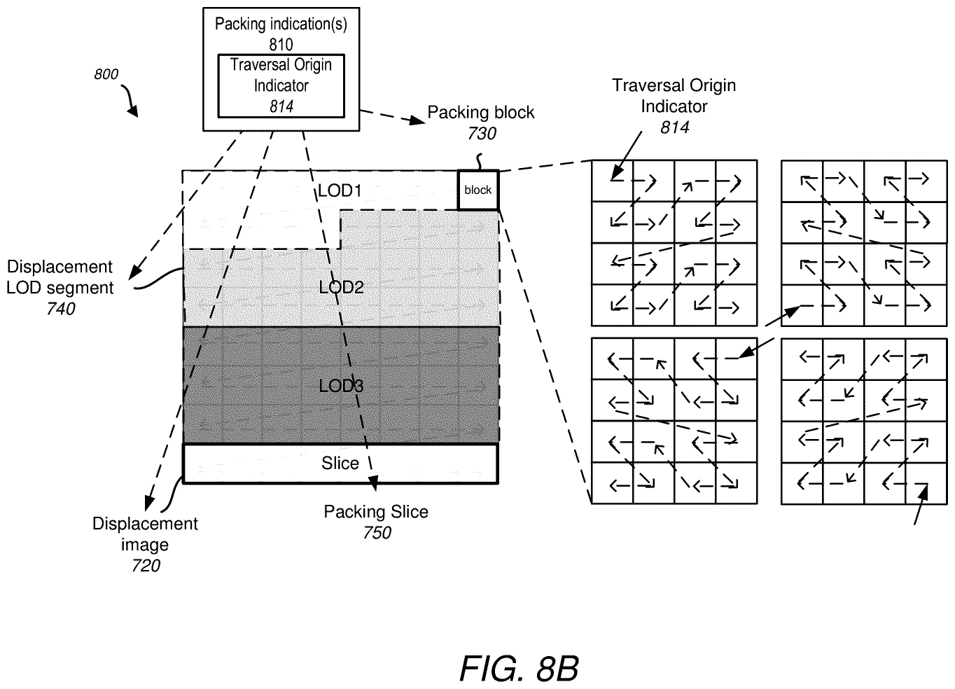

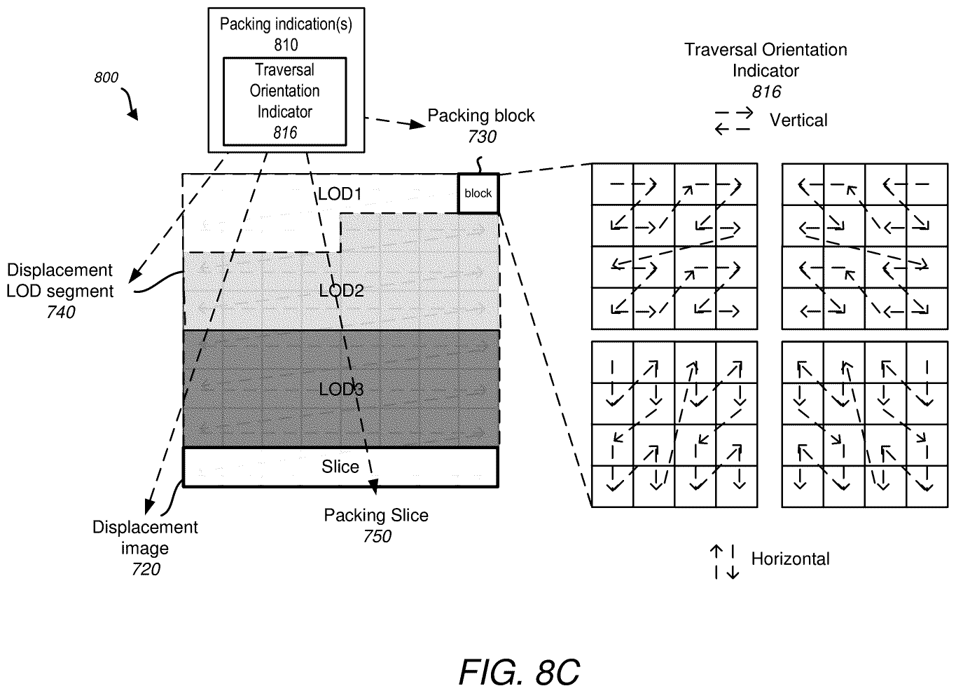

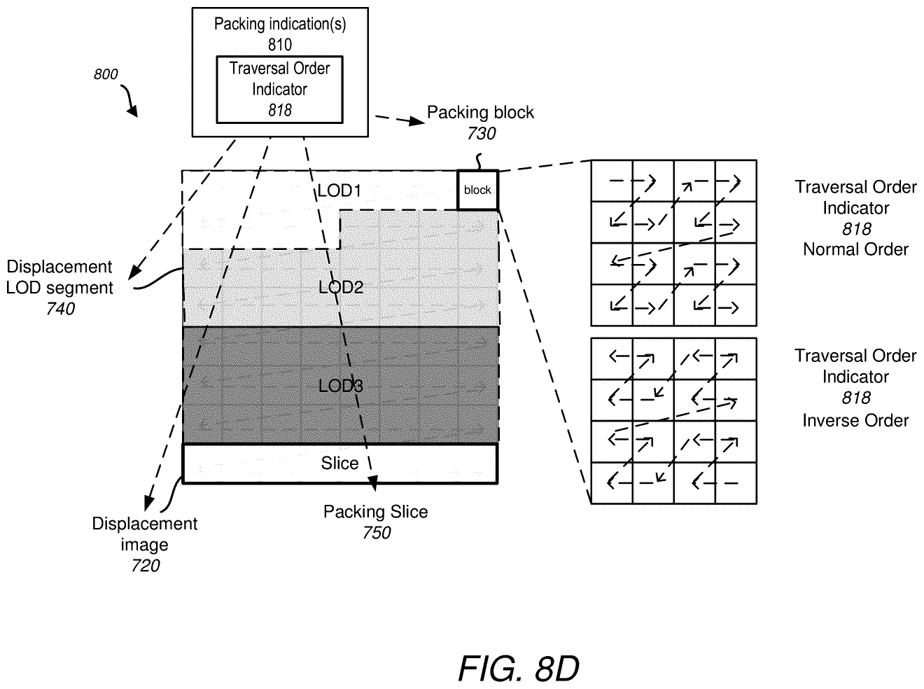

FIG. 8A illustrates an example diagram 800 of a packed displacement image with labeled LODs, including packing blocks/segments that are packed based on packing indication(s) 810 indicating traversal information with multiple traversal scheme alternatives based on traversal scheme indicator 812, according to some embodiments. The image packing may be applied by an encoder (e.g., image packer 214 of FIG. 2A and FIG. 2B). The quantized transformed wavelet coefficients representing displacements of a 3D mesh are packed into image pixels in a region of the image, according to some embodiments. For example, the displacement image 720 includes packing blocks 730 or LOD segment 740 or packing slice 750. Within either a packing block 730 or LOD segment 740 or packing slice 750, based on the packing indication(s) 810 indicating traversal information with multiple traversal scheme alternatives based on traversal scheme indicator 812, a packing scheme may be determined. For example, a Z-order or Hilbert curve may be used to determine the traversal order of the pixels within that block or segment or slice.

In some examples, a single packing scheme or multiple packing schemes or a combination of multiple packing schemes may be associated with a block or segment or slice of the displacement image 720 and signaled. For example, in an LOD segment, packing scheme adjustment is enabled and multiple packing blocks are used. Block 1 may use the packing scheme 1 and block 2 may use the packing scheme 2.

In some examples, the packing and unpacking scheme may include a first indicator 810 to indicate whether the packing scheme adjustment is enabled or not. In some examples, the indicator 810 may be signaled as a binary flag indicating if the packing scheme adjustment is enabled or not. In some examples, the indicator 810 indicator may be associated with a subset of vertices, a submesh, a packing block, an LOD segment, a packing slice or a displacement image.

In some examples, the indicator 810 may be predetermined. For example, the packing scheme adjustment is always enabled and is not required to be signaled in the bitstream. Furthermore, the corresponding traversal information indicating the packing scheme may also be predetermined and not required to be signaled.

In some examples, an indicator 810 may be predicted/derived from other available decoded indicator 810. For example, the indicator 810 of the current displacement image 720 of frame 1 may be derived from the one of frame 0. In some examples, another indicator may be required to indicate the difference between the values used for the deriving the values.

In some examples, a second indicator may be signaled to indicate traversal information when indicator 810 is enabled. For example, the second indicator 812 may be used to signal traversal information indicating the traversal scheme. In some examples, the second indicator may be associated with a subset of vertices, a submesh, a packing block, an LOD segment, a packing slice or a displacement image.

In some examples, the second indication may be signaled as an index of values indicating the value representing the traversal information. For example, 0 represents Z-order, 1 represents Hilbert curve.

FIG. 8B illustrates an example diagram 800 of a packed displacement image with labeled LODs, including packing blocks/segments that are packed based on packing indication(s) 810 indicating traversal information with multiple traversal origin alternatives based on traversal origin indicator 814, according to some embodiments. The image packing may be applied by an encoder (e.g., image packer 214 of FIG. 2A and FIG. 2B). The quantized transformed wavelet coefficients representing displacements of a 3D mesh are packed into image pixels, according to some embodiments. For example, the displacement image 720 includes packing blocks 730 or LOD segment 740 or packing slice 750. Within either a packing block 730 or LOD segment 740 or packing slice 750, based on the Packing indication(s) 810 indicating traversal information with multiple traversal origin alternatives based on traversal origin indicator 814, a packing scheme may be determined. For example, if traversal order of the pixels start from the upper left corner or the upper right corner within that block or segment or slice.

In some examples, a second indicator may be signaled to indicate traversal information when indicator 810 is enabled. For example, the second indicator (e.g., traversal origin indicator 814) may be used to signal traversal information indicating the traversal origin. In some examples, the second indicator may be associated with a subset of vertices, a submesh, a packing block, an LOD segment, a packing slice or a displacement image.

In some examples, the second indication may be signaled as an index of values indicating the value representing the traversal information. For example, 0 represents that the traversal starts from upper left corner, 1 represents that the traversal starts from the upper right corner.

In some examples, the second indication may be signaled as a value indicating the index of a pixel or a coordinate of a pixel. For example, using a 2×2 block, 0 represents that the origin is pixel 0 which is the first pixel in the upper left corner, 3 represents the last pixel that is in the lower right corner.

FIG. 8C illustrates an example diagram 800 of a packed displacement image with labeled LODs, including packing blocks/segments that are packed based on packing indication(s) 810 indicating traversal information with multiple traversal orientation alternatives based on traversal orientation indicator 816, according to some embodiments. The image packing may be applied by an encoder (e.g., image packer 214 of FIG. 2A and FIG. 2B). The quantized transformed wavelet coefficients representing displacements of a 3D mesh are packed into image pixels, according to some embodiments. For example, the displacement image 720 includes packing blocks 730 or LOD segment 740 or packing slice 750. Within either a packing block 730 or LOD segment 740 or packing slice 750, based on the Packing indication(s) 810 indicating traversal information with multiple traversal orientation alternatives based on traversal orientation indicator 816, a packing scheme may be determined. For example, if the pixels are traversed first vertically or horizontally with the determined space filling curve, in the Z-order case, the pixel with (X, Y) 2D coordinates at (0,0) will first go to (1,0) if vertical traversal is used.

In some examples, a second indicator may be signaled to indicate traversal information when indicator 810 is enabled. For example, the second indicator (e.g., which may be traversal orientation indicator 816) may be used to signal traversal information indicating the traversal orientation. In some examples, the second indicator may be associated with a subset of vertices, a submesh, a packing block, an LOD segment, a packing slice or a displacement image.

In some examples, the second indication may be signaled as a binary value indicating the vertical or horizontal mode. For example, 0 represents that the vertical mode is used and 1 presents that horizontal mode is used.

FIG. 8D illustrates an example diagram 800 of a packed displacement image with labeled LODs, including packing blocks/segments that are packed based on Packing indication(s) 810 indicating traversal information with multiple traversal order alternatives based on traversal order indicator 818, according to some embodiments. The image packing may be applied by an encoder (e.g., image packer 214 of FIG. 2A and FIG. 2B). The quantized transformed wavelet coefficients representing displacements of a 3D mesh are packed into image pixels, according to some embodiments. For example, the displacement image 720 includes packing blocks 730 or LOD segment 740 or packing slice 750. Within either a packing block 730 or LOD segment 740 or packing slice 750, based on the packing indication(s) 810 indicating traversal information with multiple traversal order alternatives based on traversal order indicator 818, a packing scheme may be determined. For example, if the pixels are traversed in a normal or inversed order. If the normal order is considered traversing from the first to the last of the pixels, then the inversed order is considered as traversing from the last to the first of the pixels.

In some examples, a second indicator may be signaled to indicate traversal information when indicator 810 is enabled. For example, the second indicator (e.g., which may be traversal order indicator 818) may be used to signal traversal information indicating the traversal order. In some examples, the second indicator may be associated with a subset of vertices, a submesh, a packing block, an LOD segment, a packing slice or a displacement image.

In some examples, the second indication may be signaled as a binary value indicating the normal or inverse traversal order mode. For example, 0 represents that the normal traversal order is used and 1 presents that inversed traversal order is used.

In some examples, the second indication may contain one or more presented second indications. For example, when the packing indication 810 is enabled, a second indication 812 may be signaled. A third indication (e.g., traversal origin indicator 814) and a fourth indication (e.g., traversal orientation indicator 816 or traversal order indicator 818) may as well be signaled together with the indication 812. The presented examples of second indications may be signaled individually or combined.

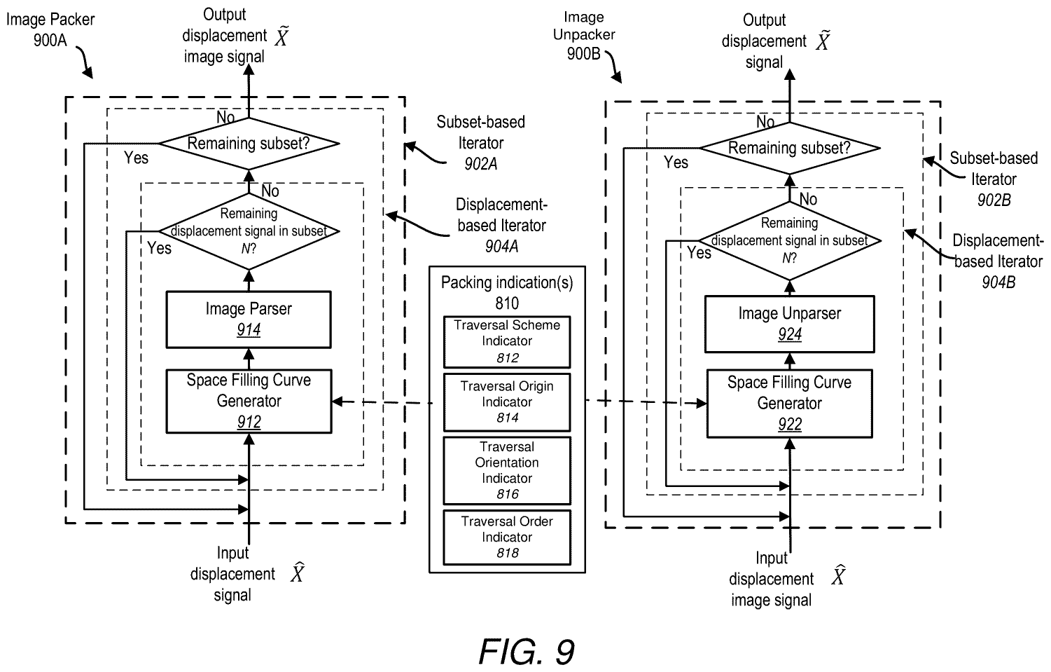

FIG. 9 illustrates an example of an image packer 900A to pack transformed-quantized wavelet coefficients representing displacements of a 3D mesh into an image and also an example of an image unpacker 900B to unpack transformed-quantized wavelet coefficients representing displacements of a 3D mesh from an image, according to some embodiments, according to some embodiments. Operations of image packer 900A may be applied by an encoder (e.g., image packer 214 of FIG. 2A-B). Image packer 900A may perform an image packing scheme with a packing scheme based on a space filling curve, according to some embodiments such as that described with respect to FIGS. 8A-D. Operations of image unpacker 900B may be applied by a decoder (e.g., image unpacker 224 of FIG. 2A-B or image unpacker 310 of FIG. 3). Image unpacker 900B may perform an image unpacking scheme with a unpacking scheme based on a space filling curve, according to some embodiments such as that describe with respect to FIGS. 8A-D.

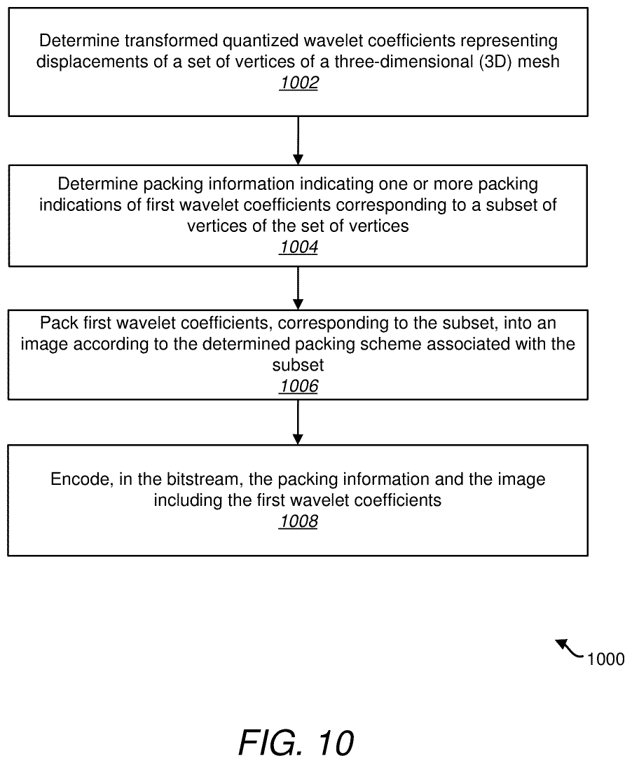

In some examples, such as that performed by image packer 214 of FIGS. 2A-B, the packing processes are iteratively applied (e.g., performed) to wavelet coefficient signals per subset of vertices (e.g., from vertices at higher LODs to vertices at lower LODs). The image packer 900A iteratively performs image packing per subset of vertices as shown in subset-based iterator 902A (e.g., from vertices at higher LODs to vertices at lower LODs). For packed transformed-quantized wavelet coefficients of vertices in each subset, image packer 900A iteratively performs image packing for each of the wavelet coefficients in the subset, as shown by displacement-based iterator 904A. Once all wavelet coefficients in a subset have been packed, image packer 900A packs wavelet coefficients in a next subset. Within each image packing operation, image packer 900A may include a space filling curve generator 912 and an image parser 914. Space filling curve generator 912 may compute the code of the space filling curve or the traversal order of the pixels to be packed into the image indicated by packing indication(s) 810, as explained above in FIGS. 8A-D and further detailed below with respect to FIG. 10. Image parser 914 may parse the transformed-quantized wavelet coefficients into pixels of the image based on the computed space filling curve traversal order from 912.

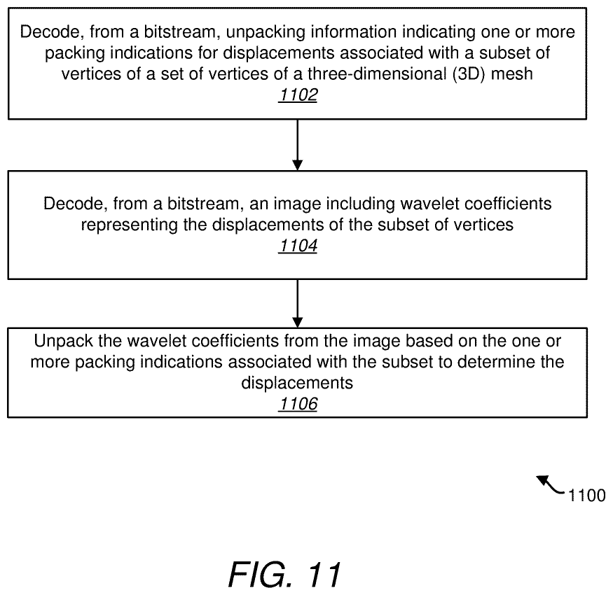

In some examples, such as that performed by image unpacker 224 of FIGS. 2A-B or image unpacker 310 of FIG. 3, the unpacking processes are iteratively applied (e.g., performed) to wavelet coefficient signals per subset of vertices (e.g., from vertices at lower LODs to vertices at higher LODs). The image unpacker 900B iteratively performs image unpacking per subset of vertices as shown in subset-based iterator 902B (e.g., from vertices at lower LODs to vertices at higher LODs). For packed transformed-quantized wavelet coefficients of vertices in each subset, image unpacker 900B iteratively performs image unpacking for each of the wavelet coefficients in the subset, as shown by displacement-based iterator 904B. Once all wavelet coefficients in a subset have been unpacked, image unpacker 900B unpacks wavelet coefficients in a next subset. Within each image unpacking operation, image unpacker 900B may include a space filling curve generator 922 and an image unparser 924. Space filling curve generator 922 may compute the code of the space filling curve or the traversal order of the pixels to be packed into the image indicated by packing indication(s) 810, as explained above in FIGS. 8A-D and further detailed below with respect to FIG. 11. Image unparser 924 may unparse the pixels of the image based on the computed space filling curve traversal order from 912 back to 1D array of transformed-quantized wavelet coefficients.

In some examples, when subsets of a set of the vertices of the 3D mesh correspond to different LODs of a plurality of LODs of the vertices, image packer/unpacker may iteratively pack/unpack signal samples (e.g., displacement signals and corresponding quantized-transformed wavelet coefficient representations) from higher LODs to lower LODs (packing) or from lower LODs to higher LODs (unpacking). For example, the transformed-quantized wavelet coefficients may be associated with different LODs such as LOD1 as shown in FIG. 8 A-D. Within each LOD, a packing/unpacking block may also be present, displacement-based iterator 904A/B iterate for each displacement within the block until all the blocks or displacements have been packed/unpacked in the LOD. Subset-based iterator 902A/B iterates for each lower/higher LOD until the lowest/highest LOD level is processed at which point all quantized wavelet coefficient signals will have been packed/unpacked in the displacement image. For example, a base mesh of 900 vertices may be subdivided into an up-sampled mesh with, e.g., 57,600 vertices across 4 LOD levels (e.g., LOD₀ comprising vertices with indexes 1-900, LOD₁ comprising vertices with indexes 901-3600, LOD₂ comprising vertices with indexes 3601-14400, and LOD₃ comprising vertices with indexes 14401-57600). In this example, the associated displacements (e.g., displacement values and quantized wavelet coefficient representations) have the same order as these vertices. In this example, image packer may start from the highest LOD, which may be LOD₃, image unpacker may start from the lowest LOD, which may be LOD₀.

In some examples, the described LOD order may be inversed. For example, the image packer may start from the lowest LOD, which may be LOD₀, image unpacker may start from the highest LOD, which may be LOD₃.

In some embodiments, space filling curve generator 912/922 may determine whether packing scheme adjustment is enabled or not based on a first indication, of packing indication(s) 810 received (e.g., decoded) from a bitstream. For example, the first indication may be received (e.g., decoded) and associated with each subset of vertices. In some examples, when subsets correspond to LODs, packing indication(s) 810 may further indicate an LOD index (indicating a specific LOD) and whether the image packing/unpacking operation of space filling curve generator 912/922 is enabled for that LOD index. When the first indication indicates that space filling curve generator 912/922 is enabled, packing indication(s) 810 may further include a second indication of the traversal information (e.g., traversal scheme, origin, orientation, order, etc.) corresponding to the LOD.

In some embodiments, space filling curve generator 912/922 is enabled by default, in which case the first indication is not signaled and only the second indication is signaled. In these embodiments, the space filling curve generator for a subset of vertices (e.g., a specific LOD) may be signaled as being equal to zero or without being signaled, which indicates that the Morton Code (or Z-order) is used to compute the traversal order of the pixels to pack the transformed-quantized coefficients into pixels.

In some examples, the first indication may be signaled for the 3D mesh (e.g., a mesh frame) or a sequence of mesh frames. In some examples, based on the first indication indicating that the packing scheme adjustment is enabled, space filling curve generator 912/922 may determine (e.g., set) set the same packing indication(s) 810 across all subsets (e.g., LODs) according to the second indication. In other examples, based on the first indication indicating that the packing scheme adjustment is enabled, space filling curve generator 912/922 may determine (e.g., set) set the packing indication(s) 810 for each subset (e.g., LODs) according to the second indication that is decoded for that specific subset.

In some embodiments, packing indication(s) 810 may include the first indication and/or the second indication signaled by the encoder to the decoder. For example, the encoder may generate and signal (e.g., encode), in a bitstream, packing indication(s) 810 based on comparing compression results between one or more image packing/unpacking processes, corresponding to one or more subsets, when packing scheme adjustment being disabled and enabled. For example, the encoder may signal packing indication(s) 810 to the decoder for space filling curve generator 912 associated with each subset of vertices to maximize compression gains (or minimize coding loss). Accordingly, image unpacker 900B (e.g., of a decoder) may apply (e.g., implements and/or performs) operations of space filling curve generator 922 according to packing indication(s) 810 signaled by the encoder.

In some examples, packing indication(s) 810 comprises a single indication that indicates whether to enable (e.g., disable or skip) the packing scheme adjustment for all LODs of the 3D mesh or a sequence of mesh frames. In some examples, packing indication(s) 810 comprises a single indication that indicates one of the LODs whose packing scheme are to be adjusted (or not adjusted) in the image packing/unpacking process. For example, the single indication may indicate the lowest LOD level (e.g., last LOD or LOD₀), corresponding to the coarsest resolution, whose associated quantization adjustment operation is to be disabled. This may be useful because the inverse quantization in that LOD is with a lower quantization level and the reconstructed signal may be an accurate enough representation of the original uncompressed signal. In this LOD, the locality of pixels may be preserved well.

In some examples, packing indication(s) 810 comprises an indication for each respective LOD of the LODs associated with vertices of the mesh frame. For example, one indication for one LOD may indicate whether packing scheme adjustment for that LOD should be enabled or disabled. At the encoder, the encoder may compare compression results between the packing scheme adjustment for the LOD being enabled and disabled to determine whether the indication of the packing scheme adjustment is signaled, in a bitstream, to the decoder is enabled or disabled. Then, the decoder may decode the indication, from the bitstream, for the corresponding LOD and selectively perform the packing scheme adjustment for wavelet coefficients of the LOD according to the indication.

In some examples, packing indication(s) 810 comprises an indication for each respective LOD of the LODs associated with vertices of the mesh frame. But, instead of the encoder comparing compression results between the packing scheme adjustment operation for the LOD being enabled and disabled to determine whether the indication of the packing scheme adjustment operation signaled, the encoder may compare compression results between enabling/disabling sets of packing scheme adjustment operations, corresponding to LODs, to determine a combination of indications that increases (e.g., maximizes) compression gains. Similarly, although the above examples are described with respect to LODs, they may similarly be applied to subsets (which are not necessarily LODs).

In some examples, an indication of packing indication(s) 810 may indicate an LOD index identifying an LOD, of LODs of the mesh frame, for which packing scheme adjustment is enabled/disabled based on the indication. For example, the indication may include the LOD index and a binary indication (e.g., binary flag) whose value indicates enabling/disabling of the packing scheme adjustment operation corresponding to the LOD index.

In some examples, packing indication(s) 810 may be signaled per sequence of 3D mesh frames, per mesh frame, per tile, per patch, per patch group, or per LOD. In some examples, one or more indications comprises an indication that may be signaled per LOD in a mesh frame.

In some embodiments, the first indication (e.g., mode indication) indicating whether packing scheme adjustment operation is enabled/disabled for each subset of vertices is not signaled between the encoder and the decoder and is predetermined. For example, packing scheme adjustment operation for wavelet coefficient signals of vertices at all LODs may be enabled without being signaled in packing indication(s) 810 which indicates that by default Z-order is used to compute the traversal order of the pixels in Space filling curve generator 912/922.

In some embodiments, packing indication(s) 810 may include a second indication (e.g., a flag, or a syntax element) signaled in the bitstream indicating the traversal scheme used by space filling curve generator 912/922 to determine (e.g., derive or compute) the space filling curve (e.g., Morton Order or Hilbert Curve or Peano Curve, Moore Curve, Sierpinski Curve, Dragon Curve, etc.) for packing the transformed-quantized wavelet coefficient into pixels with a traversal order. For example, the second indication may indicate an index to a set of space filling curves to specify one of the space filling curve, or a specific value. In some examples, the second indication may be signaled per sequence of 3D meshes, per mesh frame, per tile, per patch, per patch group, per LOD, etc.

In some embodiments, packing indication(s) 810 may include a second indication (e.g., a flag, or a syntax element) signaled in the bitstream indicating the traversal origin used by space filling curve generator 912/922 to determine (e.g., derive or compute) the origin (e.g., left upper corner, right upper corner, the first pixel, the fifth pixel, etc.) for packing the transformed-quantized wavelet coefficient into pixels with a traversal order. For example, the second indication may indicate an index to a set of the origin to specify one of the origins, or a specific value or an exponent of a specific value (e.g., the value n represents the exponent of the 2ⁿ). In some examples, the second indication may be signaled per sequence of 3D meshes, per mesh frame, per tile, per patch, per patch group, per LOD, etc.

In some embodiments, packing indication(s) 810 may include a second indication (e.g., a flag, or a syntax element) signaled in the bitstream indicating the traversal orientation used by space filling curve generator 912/922 to determine (e.g., derive or compute) the orientation (e.g., vertical or horizontal) for packing the transformed-quantized wavelet coefficient into pixels with a traversal orientation. For example, the second indication may indicate an index to a set of the orientation to specify one of the orientations, or a specific value. In some examples, the second indication may be signaled per sequence of 3D meshes, per mesh frame, per tile, per patch, per patch group, per LOD, etc.

In some embodiments, packing indication(s) 810 may include a second indication (e.g., a flag, or a syntax element) signaled in the bitstream indicating the traversal order used by space filling curve generator 912/922 to determine (e.g., derive or compute) the order (e.g., normal or inversed) for packing the transformed-quantized wavelet coefficient into pixels with a traversal order. For example, the second indication may indicate an index to a set of the origin to specify one of orders, or a specific value. In some examples, the second indication may be signaled per sequence of 3D meshes, per mesh frame, per tile, per patch, per patch group, per LOD, etc.

In some embodiments, the packing indication(s) 810 may include a second indication (e.g., a flag, or a syntax element) signaled in the bitstream indicating the traversal scheme, then it may also include a third, fourth, and fifth indication (e.g., a flag, or a syntax element) signaled in the bitstream indicating the traversal origin, orientation, and order used by space filling curve generator 912/922 to determine (e.g., derive or compute) the origin (e.g., left upper corner, right upper corner, the first pixel, the fifth pixel, etc.) for packing the transformed-quantized wavelet coefficient into pixels with a traversal order.

In some embodiments, packing indication(s) 810 may indicate a plurality of traversal indicators 812-818 corresponding to each subset of vertices, respectively. For example, a plurality of packing indication(s) 810 is signaled for subset of vertices from different LODs. For example, a plurality of traversal indicators 812-818 may be signaled for subset of vertices, e.g., vertices in a second LOD. Each traversal indicator of the plurality of packing indication(s) 810 may be signaled according to any of the embodiments described above. For example, the vertices in a second LOD packing block 1 may be packed with Morton Code order with in normal packing order while the vertices in a first LOD packing block 2 may be packed with Hilbert curve order with inversed packing order.

FIG. 10 illustrates a flowchart 1000 of an example method for applying a packing scheme to pack transformed-quantized wavelet coefficients into an image, according to some embodiments. In some examples, the method may be performed by an encoder (e.g., encoder 114 of FIG. 1, encoder 200A of FIG. 2A, or encoder 200B of FIG. 2B). The following descriptions of various steps may refer to operations described above with respect to image packer 214 of FIG. 2A-B.

At block 1002, the encoder determines transformed-quantized wavelet coefficients representing displacements of a set of vertices of a three-dimensional (3D) mesh. For example, the wavelet coefficients may be determined by a wavelet transformer (e.g., wavelet transformer 210 of FIG. 2A or FIG. 2B) and a quantizer (e.g., quantizer 212 of FIG. 2A or FIG. 2B) of the encoder. As explained above, the encoder may convert (e.g., transform) the determined displacements of the set of vertices to the wavelet coefficients according to a wavelet transform (e.g., a wavelet transform lifting scheme). The encoder may then quantize the wavelet transformed coefficients into integer quantized values.

At block 1004, the encoder determines packing information indicating one or more packing indications of first wavelet coefficients corresponding to a subset of the set of vertices. For example, the one or more packing indications may indicate a packing scheme of a plurality of packing schemes and/or include parameters such as packing indication(s) 810 and/or traversal indicator(s) 812-818 in FIG. 9. In some examples, a packing indication may be identical for subsets of the set of vertices. For example, a subset of vertices may comprise vertices at a same LOD of a plurality of LODs. For example, the subset of vertices may comprise vertices in a sub-mesh of the 3D mesh. For example, the subset of vertices may comprise vertices in a patch of the sub-mesh or 3D mesh. The packing indication(s) may be referring to a packing block, an LOD, a slice of the displacement image.

In some examples, the packing information may include a first indication of whether packing scheme adjustment operation is enabled or not. Based on the first indication, a second indication of further traversal information may contain the traversal scheme (e.g., the space filling curve), the origin (where the pixel starts), the orientation (vertical or horizontal), and the order (normal or inverse).

In some examples, the first indication is skipped, and only the second indication is signaled. In some examples, the traversal scheme is always signaled as the second indication, while the others are signaled as optional indications. In some examples, the indications are predetermined without being signaled.

In some examples, a displacement may be represented as three components, in which case a packing scheme adjustment may be applied to each component. In typical implementations, the packing scheme adjustment may be determined to be the same for each component.

In some examples, the encoder iteratively packs the wavelet coefficients of each subset of subsets of the set of vertices. For example, when each subset corresponds to vertices in a same LOD of LODs, the encoder may iteratively pack wavelet coefficients per subset according to an order of the LODs (e.g., from higher LODs to lower LODs).

At block 1006, the encoder packs, in an image, the first wavelet coefficients (e.g., after being transformed and quantized) according to the determined packing indications associated with the subset. For example, the transformed-quantized first wavelet coefficients may be packed in a region of the image such as a packing block of block blocks. For example, the packing indications may specific a packing scheme to apply to pack the first wavelet coefficients into the image.

In some examples, the packing information may further indicate one or more parameters for packing such as the traversal parameter. As explained above, the packing information may be signaled for each subset of vertices, per sequence of 3D meshes, per mesh frame, per tile, per patch, per patch group, per LOD, etc.

At block 1008, the encoder encodes, in the bitstream, the packing information, and the packed image containing the first (transformed-quantized) wavelet coefficients of the displacements. As explained above, the encoder may use video codec to encode the packed image of displacements.

In some examples, each of the packing information may be signaled for each subset of vertices. In an example, one or more parameters may be associated with each packing scheme and included in the packing information. For example, one or more parameters may include a value of the space filling curve mode, one or more origin indexes, etc.

In some examples, the indicator (or indication) of the packing scheme may be entropy coded, e.g., using a unary code, a Rice code, a Golomb code, an Exp-Golomb code, or the like.

In some examples, the packing information comprises an indication of whether packing scheme adjustment is enabled (e.g., selectively enable or disable packing scheme adjustment per subset of vertices) for each subset of the (non-overlapping) subsets of vertices. For example, if a subset corresponds to one mesh frame (e.g., the 3D mesh) in a sequence of mesh frames, the indication may be signaled per mesh frame. For example, if a subset corresponds to an LOD, the indication may be signaled per LOD. For example, the indication (e.g., mode indication for packing scheme adjustment) may be signaled per sequence of 3D mesh frames, per mesh frame, per sub-mesh, per tile, per patch group, per patch, and/or per LOD.

In some examples, the encoder may compare compression results (e.g., a rate distortion optimization (RDO) cost) of the image packing/unpacking between the packing scheme adjustment operations, corresponding to the subset, being disabled and enabled to determine the indication. For example, if compression gains is increased (e.g., less bits being required to be generated in displacement bitstream 260) with the packing scheme adjustment operation being enabled, the encoder may determine the indication of the packing scheme adjustment operation as being enabled and further indicate, in the packing information, a second indication of the traversal indication(s).

In some examples, the indication of the packing scheme adjustment operation may be entropy coded, e.g., using a unary code, a Rice code, a Golomb code, an Exp-Golomb code, or the like.

In some examples, the encoder may signal (e.g., encode) the transformed-quantized wavelet coefficients representing displacements of the set of vertices in 2D images. For example, the wavelet coefficients for the vertices of the 3D mesh may be arranged (e.g., packed) by an image packer (e.g., image packer 214 of FIG. 2A and FIG. 2B) into a 2D image (e.g., displacement image 720 in FIG. 7A). In some examples, the wavelet coefficients may be quantized by a quantizer (e.g., quantizer 212 of FIG. 2A and FIG. 2B) before being arranged by the image packer, as described in FIG. 2A and FIG. 2B. Further, the 2D images may be encoded by a 2D video codec such as video encoder 216 described in FIG. 2A and FIG. 2B.

FIG. 11 illustrates a flowchart 1100 of an example method for applying an unpacking scheme to unpack transformed-quantized wavelet coefficients from an image, according to some embodiments. In some examples, the method may be performed by a decoder (e.g., decoder 120 of FIG. 1, decoder 300 of FIG. 3). The following descriptions of various steps may refer to operations described above with respect to image unpacker 224 of FIG. 2A-B, or image unpacker 310 of FIG. 3.

At block 1102, the decoder decodes, from a bitstream, unpacking information indicating one or more packing indications for displacements associated with a subset of vertices of a set of vertices of a three-dimensional (3D) mesh. For example, the one or more packing indications may be related to how transformed-quantized wavelet coefficients contained in the image are to be unpacked from the image. In other words, transformed-quantized wavelet coefficients may be extracted from the decoded image and stored in an order/sequence in accordance with the one or more packing indications. In some examples, the decoder may determine the unpacking scheme to apply to the decoded image based on the one or more packing indications.

In some examples, the plurality of unpacking information corresponds to a sequence of 3D meshes including the 3D mesh. For example, the unpacking information may be associated with a subset of vertices across mesh frames of the sequence of 3D meshes, such as vertices across the mesh frames at a same LOD of a plurality of LODs.

In some examples, the unpacking information further indicates a respective plurality of unpacking information associated with each subset of the non-overlapping subsets. For example, each subset may be associated with a different LOD of LODs associated with the vertices of the 3D mesh, in which case the subset of vertices includes only vertices at a first (same) LOD of the plurality of LODs, and the vertex is in the subset based on the vertex being at the first LOD.

In some embodiments, the unpacking information includes an indicator indicating each unpacking information of the plurality of unpacking information, as explained above. In some examples, the indicator may include a value of the space filling curve mode, one or more origin indexes. In some examples, the indicator selects the traversal scheme from a list of traversal schemes (e.g., an array or a table), which may be signaled by the encoder to the decoder. For example, the indicator may be an index into the list.

In some embodiments, the plurality of unpacking information may be associated with a plurality of intervals of values, respectively. For example, the plurality of intervals may include non-overlapping ranges of values.

In some embodiments, the decoder receives (e.g., decodes), from the bitstream, an indication (e.g., mode indication) of whether packing scheme adjustment is enabled. The adjusting of the wavelet coefficient may be based on the indication of packing scheme adjustment being enabled.

In some examples, the mode indication may be received for each subset of the non-overlapping subset of vertices. In some examples, the mode indication may be received (and decoded) for a sequence of 3D meshes including the 3D mesh or per 3D mesh frame. Similar to the indication of the unpacking scheme, the one or more mode indications may be signaled per sequence of 3D mesh frames, per mesh frame, or per subset of vertices corresponding to per sub-mesh of the mesh frame/3D mesh, per patch group of the sub-mesh of the 3D mesh/mesh frame, per tile, per patch in a patch group, or per LOD. In some examples, based on the mode indication indicating no packing scheme adjustment, space filling curve generator 912/922 will only use Morton Code as the only solution and operation at block 1004, 1102 would be skipped (e.g., omitted).

In some examples, where the subsets correspond to different LODs, one or more mode indications may be decoded, from the bitstream, selectively enabling the packing scheme adjustment for specific LODs of the LODs. For example, the one or more mode indications may comprise an index of the LOD (e.g., identifying the LOD) and a binary indication of whether the packing scheme adjustment operation corresponding to the LOD is enabled or disabled (e.g., skipped).

In some examples, the received unpacking information is determined by an encoder. For example, the values of the unpacking information associated with a subset of vertices may be determined (derived/computed) from the difference between unpacking information from different subsets of vertices or frames, etc.

Related to the encoding of the indication (e.g., mode indication) of whether packing scheme adjustment is enabled and/or the indication of the unpacking information described above in FIG. 10, the decoder may perform entropy decoding to decode the mode indication and/or the indication of the quantization offset from the bitstream.

At block 1104, the decoder decodes, from the bitstream, an image including (e.g., containing) the first transformed-quantized wavelet coefficients representing the displacements of the subset of vertices. For example, pixels of the image may be decoded. For example, the pixels of the packed image may be the same as the pixels of the packed image encoded by the encoder at block 1008 of FIG. 10.

In some examples, the set of vertices are ordered according to levels of detail (LODs) of the vertices, and the quantized wavelet coefficients may be decoded from the bitstream according to LODs. For example, the decoder may apply, in the order, an inverse wavelet transform (e.g., an inverse lifting scheme) to transformed wavelet coefficients, received in the bitstream, to determine (non-transformed) quantized wavelet coefficients including the quantized wavelet coefficient.

In some examples, the quantized wavelet coefficients are decoded based on decoding, from the bitstream, an image (e.g., a 2D image) including transformed wavelet coefficients. The decoder may determine the transformed wavelet coefficients, from the decoded image, according to a packing order of wavelet coefficients in the image. For example, the quantized wavelet coefficients are arranged (e.g., packed) by an image packer at the encoder into a 2D image (e.g., displacement image 720 in FIG. 7A). Accordingly, the decoder may include a video decoder (e.g., video decoder 308 of FIG. 3) that decodes the 2D image containing the quantized wavelet coefficients. The decoder may include an image unpacker (e.g., image unpacker 310 of FIG. 3) to reverse (e.g., unpack) operation of the image packer to determine a sequence of quantized wavelet coefficients. In some examples, the decoder may include an inverse quantizer (e.g., inverse quantizer 312) to inverse quantize the unpacked first wavelet coefficients.

In some embodiments, the set of vertices includes non-overlapping subsets of vertices with the subset being one of the non-overlapping subsets. In some examples, the non-overlapping subsets correspond to levels of detail (LODs). In some examples, the non-overlapping subsets correspond to sub-meshes of the 3D mesh. In some examples, the non-overlapping subsets correspond to patches in a sub-mesh of the sub-meshes.

At block 1106, the decoder unpacks the first wavelet coefficients (e.g., transformed-quantized wavelet coefficients) from the image based on the one or more packing indications associated with the subset to determine the displacements. For example, an ordering or sequence of the first wavelet coefficients stored in a region of the image may be determined according to the one or more packing indications. In some examples, pixels decoded from the decoded displacement image may represent decoded first wavelet coefficients and may be unpacked into an array of transformed-quantized wavelet coefficients according to the determined one or more packing indications associated with the subset of vertices. The one or more packing indications may specific a packing/unpacking scheme from a plurality of packing schemes.

In some examples, a displacement may be represented as three components, in which case an inverse quantization scaling factor may be applied to each component. In typical implementations, the inverse quantization scaling factor may be determined to be the same for each component.

In some examples, the decoder may further inverse quantize the wavelet coefficient (that has been unpacked from the decoded image) to reconstruct the displacement for the vertex.

In some examples, the decoder may further inverse transform the wavelet coefficient (that has been inverse quantized) to reconstruct the displacement for the vertex. For example, the decoder (e.g., inverse wavelet transformer 220 of FIGS. 2A-2B, or inverse wavelet transformer 314 of FIG. 3) may apply an inverse quantizer (e.g., an inverse lifting scheme) to the inverse-quantized wavelet coefficients to determine reconstructed displacements. In some examples, the decoder may iteratively apply the inverse transform for each subset of inverse-quantized wavelet coefficients. For example, where subsets correspond to LODs, the decoder may iteratively apply the inverse transform to the inverse-quantized wavelet coefficients in each LOD according to an order of the LODs (e.g., in increasing order).

In some examples, the decoder reconstructs a geometry of the 3D mesh based on the determined displacement (and similarly determined displacement of vertices of the set of vertices of the 3D mesh). In some examples, the decoder may reconstruct the geometry based on the displacements and a base mesh. For example, the decoder may decode, from the bitstream, a base mesh associated with the 3D mesh. Then, the decoder may iteratively apply a subdivision scheme to the base mesh to generate positions of vertices of a subdivided base mesh, where each subset of the subsets is associated with an iteration of subdivision. To reconstruct the geometry of the 3D mesh, the decoder may add the displacement, of the vertex, to a position of a corresponding vertex of the subdivided base mesh. The reconstructed 3D mesh may be determined after applying determined displacements to corresponding vertices of the subdivided base mesh.

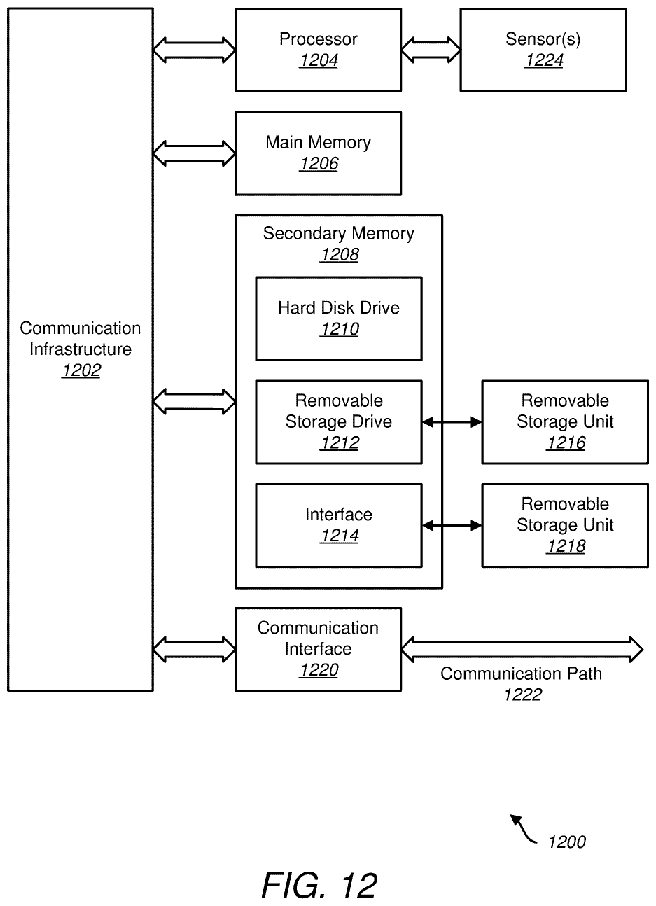

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 1200 is shown in FIG. 12. Blocks depicted in the figures above, such as the blocks in FIG. 1, may execute on one or more computer systems 1200. Furthermore, each of the steps of the flowcharts depicted in this disclosure may be implemented on one or more computer systems 1200. When more than one computer system 1200 is used to implement embodiments of the present disclosure, the computer systems 1200 may be interconnected by one or more networks to form a cluster of computer systems that may act as a single pool of seamless resources. The interconnected computer systems 1200 may form a “cloud” of computers.

Computer system 1200 includes one or more processors, such as processor 1204. Processor 1204 may be, for example, a special purpose processor, general purpose processor, microprocessor, or digital signal processor. Processor 1204 may be connected to a communication infrastructure 1202 (for example, a bus or network). Computer system 1200 may also include a main memory 1206, such as random access memory (RAM), and may also include a secondary memory 1208.

Secondary memory 1208 may include, for example, a hard disk drive 1210 and/or a removable storage drive 1212, representing a magnetic tape drive, an optical disk drive, or the like. Removable storage drive 1212 may read from and/or write to a removable storage unit 1216 in a well-known manner. Removable storage unit 1216 represents a magnetic tape, optical disk, or the like, which is read by and written to by removable storage drive 1212. As will be appreciated by persons skilled in the relevant art(s), removable storage unit 1216 includes a computer usable storage medium having stored therein computer software and/or data.

In alternative implementations, secondary memory 1208 may include other similar means for allowing computer programs or other instructions to be loaded into computer system 1200. Such means may include, for example, a removable storage unit 1218 and an interface 1214. Examples of such means may include a program cartridge and cartridge interface (such as that found in video game devices), a removable memory chip (such as an EPROM or PROM) and associated socket, a thumb drive and USB port, and other removable storage units 1218 and interfaces 1214 which allow software and data to be transferred from removable storage unit 1218 to computer system 1200.

Computer system 1200 may also include a communications interface 1220. Communications interface 1220 allows software and data to be transferred between computer system 1200 and external devices. Examples of communications interface 1220 may include a modem, a network interface (such as an Ethernet card), a communications port, etc. Software and data transferred via communications interface 1220 are in the form of signals which may be electronic, electromagnetic, optical, or other signals capable of being received by communications interface 1220. These signals are provided to communications interface 1220 via a communications path 1222. Communications path 1222 carries signals and may be implemented using wire or cable, fiber optics, a phone line, a cellular phone link, an RF link, and other communications channels.

Computer system 1200 may also include one or more sensor(s) 1224. Sensor(s) 1224 may measure or detect one or more physical quantities and convert the measured or detected physical quantities into an electrical signal in digital and/or analog form. For example, sensor(s) 1224 may include an eye tracking sensor to track the eye movement of a user. Based on the eye movement of a user, a display of a point cloud may be updated. In another example, sensor(s) 1224 may include a head tracking sensor to the track the head movement of a user. Based on the head movement of a user, a display of a point cloud may be updated. In yet another example, sensor(s) 1224 may include a camera sensor for taking photographs and/or a 3D scanning device, like a laser scanning, structured light scanning, and/or modulated light scanning device. 3D scanning devices may obtain geometry information by moving one or more laser heads, structured light, and/or modulated light cameras relative to the object or scene being scanned. The geometry information may be used to construct a point cloud.

As used herein, the terms “computer program medium” and “computer readable medium” are used to refer to tangible storage media, such as removable storage units 1216 and 1218 or a hard disk installed in hard disk drive 1210. These computer program products are means for providing software to computer system 1200. Computer programs (also called computer control logic) may be stored in main memory 1206 and/or secondary memory 1208. Computer programs may also be received via communications interface 1220. Such computer programs, when executed, enable the computer system 1200 to implement the present disclosure as discussed herein. In particular, the computer programs, when executed, enable processor 1204 to implement the processes of the present disclosure, such as any of the methods described herein. Accordingly, such computer programs represent controllers of the computer system 1200.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the relevant art(s).

What is claimed is:

1. A method comprising:
decoding, from a bitstream, unpacking information indicating one or more packing indications for displacements associated with a subset of vertices of a set of vertices of a three-dimensional mesh;
decoding, from the bitstream, an image comprising wavelet coefficients representing the displacements of the subset of vertices; and
unpacking, based on the one or more packing indications associated with the subset, the wavelet coefficients from the image to determine the displacements.

2. The method of claim 1, wherein the one or more packing indications comprise an indication of a packing scheme, from a plurality of packing schemes, for packing wavelet coefficients in a packing block of the image.

3. The method of claim 1, wherein the one or more packing indications comprise an indication of a traversal origin of packing within a packing block of the image, and wherein the traversal origin is a corner in the packing block.

4. The method of claim 1, wherein the one or more packing indications comprise an indication of a traversal orientation of packing within a packing block of the image, and wherein the traversal orientation is one of a horizontal direction or a vertical direction.

5. The method of claim 1, wherein the one or more packing indications comprise an indication of a traversal order of packing within a packing block of the image, and wherein the traversal order comprises a normal order or an inverse order.

6. The method of claim 1, wherein the set of vertices comprises non-overlapping subsets of vertices with the subset being one of the non-overlapping subsets, and wherein the non-overlapping subsets correspond to:
levels of detail (LODs);
sub-meshes of the three-dimensional mesh; or
patches in a sub-mesh of the sub-meshes.

7. The method of claim 1, wherein the wavelet coefficients are quantized-transformed wavelet coefficients stored in respective pixels of the image.

8. A decoder comprising:
one or more processors; and
memory storing instructions that, when executed by the one or more processors, cause the decoder to:
decode, from a bitstream, unpacking information indicating one or more packing indications for displacements associated with a subset of vertices of a set of vertices of a three-dimensional mesh;
decode, from the bitstream, an image comprising wavelet coefficients representing the displacements of the subset of vertices; and
unpack, based on the one or more packing indications associated with the subset, the wavelet coefficients from the image to determine the displacements.

9. The decoder of claim 8, wherein the one or more packing indications comprise an indication of a packing scheme, from a plurality of packing schemes, for packing wavelet coefficients in a packing block of the image.

10. The decoder of claim 8, wherein the one or more packing indications comprise an indication of a traversal origin of packing within a packing block of the image, and wherein the traversal origin is a corner in the packing block.

11. The decoder of claim 8, wherein the one or more packing indications comprise an indication of a traversal orientation of packing within a packing block of the image, and wherein the traversal orientation is one of a horizontal direction or a vertical direction.

12. The decoder of claim 8, wherein the one or more packing indications comprise an indication of a traversal order of packing within a packing block of the image, and wherein the traversal order comprises a normal order or an inverse order.

13. The decoder of claim 8, wherein the set of vertices comprises non-overlapping subsets of vertices with the subset being one of the non-overlapping subsets, and wherein the non-overlapping subsets correspond to:
levels of detail (LODs);
sub-meshes of the three-dimensional mesh; or
patches in a sub-mesh of the sub-meshes.

14. The decoder of claim 8, wherein the wavelet coefficients are quantized-transformed wavelet coefficients stored in respective pixels of the image.

15. A non-transitory computer-readable medium comprising instructions that, when executed by one or more processors of a decoder, cause the decoder to:
decode, from a bitstream, unpacking information indicating one or more packing indications for displacements associated with a subset of vertices of a set of vertices of a three-dimensional mesh;
decode, from the bitstream, an image comprising wavelet coefficients representing the displacements of the subset of vertices; and
unpack, based on the one or more packing indications associated with the subset, the wavelet coefficients from the image to determine the displacements.

16. The non-transitory computer-readable medium of claim 15, wherein the one or more packing indications comprise an indication of a packing scheme, from a plurality of packing schemes, for packing wavelet coefficients in a packing block of the image.

17. The non-transitory computer-readable medium of claim 15, wherein the one or more packing indications comprise an indication of a traversal origin of packing within a packing block of the image, and wherein the traversal origin is a corner in the packing block.

18. The non-transitory computer-readable medium of claim 15, wherein the one or more packing indications comprise an indication of a traversal orientation of packing within a packing block of the image, and wherein the traversal orientation is one of a horizontal direction or a vertical direction.

19. The non-transitory computer-readable medium of claim 15, wherein the one or more packing indications comprise an indication of a traversal order of packing within a packing block of the image, and wherein the traversal order comprises a normal order or an inverse order.

20. The non-transitory computer-readable medium of claim 15, wherein the set of vertices comprises non-overlapping subsets of vertices with the subset being one of the non-overlapping subsets, and wherein the non-overlapping subsets correspond to:
levels of detail (LODs);
sub-meshes of the three-dimensional mesh; or
patches in a sub-mesh of the sub-meshes.
